(19) United States
(12) Patent Application Publication
(10) Pub. No.: US 2007/0285697 A1
(43) Pub. Date: Dec. 13, 2007

(54) PRINTER

(75) Inventors: Yoshihito Ebina, Miyagi (JP); Tomohiro Monden, Miyagi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 11/685,487

(22) Filed: Mar. 13, 2007

(30) Foreign Application Priority Data
Jun. 13, 2006 (JP) 2006-163553

(51) Int. Cl. G06K 15/00

(52) U.S. Cl. 358/1.12

(57) ABSTRACT

A printer is capable of simply carrying out image division printing (repeat printing), and capable of reducing the number of images that are unusable due to clipping of the image on the leading edge of the sheet. The printer has an image division printing function of forming a plurality of print images on a single sheet, and comprises: an image reading unit that reads document images; a plate making unit that makes master plates; a printing unit having a cylinder around which a master made in the plate making unit is wound, and a pressure member that presses sheets against the cylinder; and a sheet supply unit that supplies sheets to the printing unit. The printer also comprises an image size input device for inputting the length of the document image in the main scanning direction and the sub scanning direction; and a sheet size detection device for detecting the size of the sheets, and when using the image division printing function, the print images corresponding to the document images formed on the sheet are arranged by being rotated through 180 degrees, based on the image size input by the image size input device and the detection results of the sheet size detection device.

### BACKGROUND OF THE INVENTION

1. Field of the Invention

The present invention relates to a printer in which a master is wound around the outer peripheral surface of a cylinder to perform printing, and more particularly to a printer having an image division and printing function of forming a plurality of printed images on a sheet, and a double-sided printing function capable of printing on both sides of a sheet.

2. Description of the Background Art

A commonly known example of a printer in which a master is wound around the outer periphery of a cylinder to perform printing is a thermal digital stencil printer. This printer uses a rotatable cylinder formed from a perforated support plate, which is a perforated support cylinder, on the peripheral surface of which a plurality of layers of resin or metal mesh screens are wound, and a laminated master. The laminated master is formed from a thermoplastic resin film (normally a thickness between 1 to 3 μm is used) applied to a porous support member made from Japanese paper fibers, or synthetic fibers, or a mixture of Japanese paper fibers and synthetic fibers. The thermoplastic film surface of the master is thermally stenciled by heating means of a thermal head or similar, and the master is wound around the cylinder. Ink is provided from ink supply means within the cylinder. Sheets supplied from a sheet supply unit are continuously pressed against the stenciled master on the outer peripheral surface of the cylinder by pressure means such as a press roller or similar. In this way ink is forced through the perforations of the cylinder and the holes in the master, and the image is transferred to the sheet.

Recently fully automatic type stencil printers as described above in which the document reading operation, plate discharge operation, plate making operation, plate setting operation, and printing operation are automatically and continuously carried out have become the mainstream. In this fully-automatic type of stencil printer, the document to be printed is set in an image reading unit, the number of copies to be printed is input, and the start key is pressed. Then the document images are read in the image reading unit, and a used master that is wound around the outer peripheral surface of the cylinder is removed from the cylinder. Then in a plate making unit having thermal heads, platen roller, and so on, a master is thermally stenciled, and then the plate is automatically wound around the cylinder. Then the cylinder is rotated at low speed, and one sheet is supplied from the sheet supply unit and pressed by a pressure member against the stenciled master wound onto the outer peripheral surface of the cylinder. After this plate setting operation is finished, the cylinder is rotated at high speed, and sheets are supplied continuously from the sheet supply unit. The supplied sheets are printed successively by being pressed against the outer peripheral surface of the cylinder by the pressure member.

This fully-automatic type of stencil printer includes document size detection means to detect the size of documents set in the image reading unit, and sheet size detection means that detects the size of sheets set in the sheet supply unit. The plate making operation is only carried out when the size of the document is equal to or smaller than the sheet size. Assume for example, in a stencil printer capable of printing a maximum A3 size, the document set in the image reading unit is B4 size, and the sheets set in the sheet supply unit are A4 size. If the plate making operation is carried out under these conditions, a master with a B4 size plate image is wound around the cylinder. However, if the printing operation is carried out under these conditions, A4 size sheets that are smaller than the B4 size plate image are pressed by the pressure member. Therefore, the ink that passes through the plate image that extends beyond the sheet is not transferred to the sheet, but is transferred to the pressure member. In this way, the interior of the apparatus becomes contaminated. To prevent this type of faulty operation, the printer is configured so that when the document size is larger than the sheet size, the plate is made with an image whose size is only such that the image will fit within the sheet (in this example, only an A4 size image is made from the B4 size document).

However, the document size detection means referred to above can only detect regular sized documents (for example, postcard, A5, B5, A4, B4, A3). Therefore, when printing irregular sized sketches, labels, and so on, the document size is determined to be the nearest regular size larger than the document size. Therefore, it is not possible to print the print images efficiently with respect to the sheet. Although it is not problematic when a single print image is formed on a sheet, in the case of image division printing such as repeat printing in which a plurality of images is formed on a single sheet (a plurality of the same image is formed), or collective printing (in which a plurality of different images is formed), the margin portions become too large, and the printing efficiency is greatly reduced.

To solve this problem, a stencil printer with an edge elimination function (the function that prevents the formation of dark edges around a printed image) is used. The size of an irregular sized document is specified as the image size for which edge elimination is applied. This is stored as an initial value, and after the image division printing function has been set, the stored initial value can be called up and printing is carried out. However this operation has the problem that it is very tedious and difficult for the ordinary user to master.

Therefore, a stencil printer having a repeat function is disclosed in Japanese Patent Application Laid-open No. 2001-347739. In this printer the length of the document (length in the sub scanning direction) is set, and the length of the sheets in the sub scanning direction is detected. Then by dividing the length of the sheet in the sub scanning direction by the length of the document the number of document images that will fit onto the sheet is calculated. The plate is made with the same document images formed in accordance with the calculated number, and printing is carried out.

Also, in recent years, to reduce the consumption of paper and the space for storing documents, double-sided printing in which both sides of a sheet is printed is frequently carried out with stencil printers. In the conventional method of double-sided printing, sheets stored in a sheet supply unit are supplied to the printing unit, and after being printed on one side, the sheets are reversed and again fed to the printing unit where the other side is printed to obtain double-sided printing. However, this has the problem that sheets that have been once discharged must be set again in the sheet supply unit, and this work of arranging the sheets that have been printed on one side is troublesome. Also, there is the problem that sheets are fed to the printing unit twice, so the net printing time is double that of single-sided printing, so too much time is required.

To solve these problems, double-sided printers are disclosed in, for example, Japanese Patent Application Laid-open No. 2003-200645, and Japanese Patent Application Laid-open No. 2003-237207. In these printers divided plate masters in which a first plate image and a second plate image are aligned in the direction of rotation of the cylinder are used. The first sheet is supplied from the sheet supply unit, and after one of the plate images is printed on the front surface, the sheet is guided to an auxiliary tray. The second sheet is supplied from the sheet supply unit, and after one of the plate images is printed on the front surface, the sheet is guided to an auxiliary tray. In addition, the first sheet is re-supplied from the auxiliary tray and the other plate image is printed on the rear surface, and this sheet is discharged to the discharge tray. By carrying out this process continuously, it is possible to obtain double-sided printing in one operation.

In the conventional art described above, only the length of the document in the sub scanning direction is set. Therefore, it is not possible to deal with the case where there is excess image in the main scanning direction. Also, there is the problem that setting is carried out in accordance with the document length, so clipped incomplete images are formed on the sheets (or when masking is carried out, unwanted margins are formed).

Also, in a stencil printer, in order to separate the sheet from the master wound around the cylinder after printing, a portion of about 5 mm on which no image is transferred is formed on the leading edge of the sheet. Therefore, when carrying out repeat printing of a document with no margins on the leading edge, the repeat images arranged on the leading edge of the sheet are printed with a clipped portion on the leading edge.

Further, when carrying out double-sided printing with the double-sided printer with a repeat function referred to previously, the standard positions of the front and rear of the sheets are different, so there is the problem that the image positions do not coincide on front and rear.

### SUMMARY OF THE INVENTION

With the foregoing in view, it is an object of the present invention to solve the problem points of conventional art by providing a printer in which even if a document has excess image in the main scanning direction, by setting the necessary portion, image division printing can be easily carried out, and that is capable of reducing the number of unusable images due to image clipping at the leading edge of the sheet.

Also, another object of the present invention is to provide a printer in which when double-sided printing is carried out, the print positions can be aligned front and rear when opening vertically.

Furthermore, it is another object of the present invention to provide a printer in which when double-sided printing is carried out, the print positions can be aligned front and rear when opening left to right.

Furthermore, it is also another object of the present invention to provide a printer in which when double-sided printing is carried out, the print positions can be aligned front and rear for either vertical opening or opening left to right, and at the same time the number of unusable images due to image clipping at the leading edge of the sheet can be reduced.

In an aspect of the present invention, a printer has an image division printing function of forming a plurality of print images on a single sheet and comprises an image reading unit that reads document images; a plate making unit that makes master plates; a printing unit having a cylinder around which a master made in the plate making unit is wound, and a pressure member that presses sheets against the cylinder; a sheet supply unit that supplies sheets to the printing unit; an image size input unit for inputting the length of the document image in a main scanning direction and a sub scanning direction; and a sheet size detection unit for detecting the size of the sheets. When using the image division printing function, print images corresponding to the document images formed on the sheet are arranged by being rotated through 180 degrees, based on the image size input by the image size input unit and the detection results of the sheet size detection unit.

In another aspect of the present invention, a printer has an image division printing of forming a plurality of print images on a single sheet, and a double-sided printing function of printing both sides of the sheet and comprises a printing unit having a cylinder around the outer peripheral surface of which a divided plate master having a first plate image and a second plate image aligned in a length direction is wound, and a pressure member that can freely contact with and separate from the cylinder; a sheet supply unit that supplies sheets to the printing unit; a sheet discharge unit that discharges sheets that have been printed in the printing unit outside the printer; an auxiliary tray that temporarily stores sheets for which a print image has been formed on the front surface thereof in the printing unit; a sheet re-supply unit for re-supplying to the printing unit the sheets that have been printed on the front surface thereof and that are stored in the auxiliary tray; a switching member that guides sheets that have passed the printing unit to either the auxiliary tray or the sheet discharge unit; an image size input unit for inputting the length of a document image in a main scanning direction and a sub scanning direction; and a sheet size detection unit for detecting the size of the sheets. When using the image division printing function, print images corresponding to the document images formed on the sheet are arranged by carrying out either one or both of a rotation through 180 degrees process and a centering process, based on the image size input by the image size input unit and the detection results of the sheet size detection unit.

### BRIEF DESCRIPTION OF THE DRAWINGS

The above and other objects, features, and advantages of the present invention will become more apparent from the following detailed description taken with the accompanying drawings in which:

FIG. 1 is a diagram showing the schematic structure of a printer according to an embodiment of the present invention;

FIG. 2 is a plan view showing an example of the operation panel of the printer;

FIG. 3 is a block diagram showing an example of the configuration of the control system of the printer;

FIG. 4 is a diagram showing the schematic structure of a printer according to another embodiment of the present invention;

FIG. 5 is a plan view showing an example of the operation panel of the printer;

FIG. 6 is a block diagram showing an example of the configuration of the control system of the printer;

FIG. 7 is a diagram for explaining repeat printing;

FIG. 8 is a diagram for explaining collective printing;

FIG. 9 is a diagram for explaining the problem points when repeat printing is conventionally carried out;

FIG. 10 is a diagram showing an example of carrying out repeat printing using a 180 degree rotation process;

FIG. 11 is a diagram showing an example of repeat printing using a centering process in the main scanning direction;

FIG. 12 is a diagram showing an example of carrying out repeat printing on both sides of a sheet using a 180 degree rotation process, and an example of repeat printing on both sides of a sheet using a 180 degree rotation process and a centering process in the main scanning direction;

FIG. 13 is a flowchart showing an example of the control operation of the prepress process;

FIG. 14 is a diagram showing an example of conventional left to right opening double sided repeat printing, and an example of left to right opening double-sided repeat printing according to the present invention;

FIG. 15 is a diagram showing an example of making the image on the reverse side when carrying out left to right opening double-sided printing;

FIG. 16 is a flowchart showing the control operation of the prepress operation when making the plate for the rear surface;

FIG. 17 is a diagram showing an example of repeat printing using a centering process carried out in both the main scanning direction and sub scanning direction; and

FIG. 18 is a flowchart showing another example of the control operation of the prepress process.

### DESCRIPTION OF THE PREFERRED EMBODIMENTS

The following is a detailed explanation of an embodiment of a printer having an image division and printing function according to the present invention.

### Embodiment 1

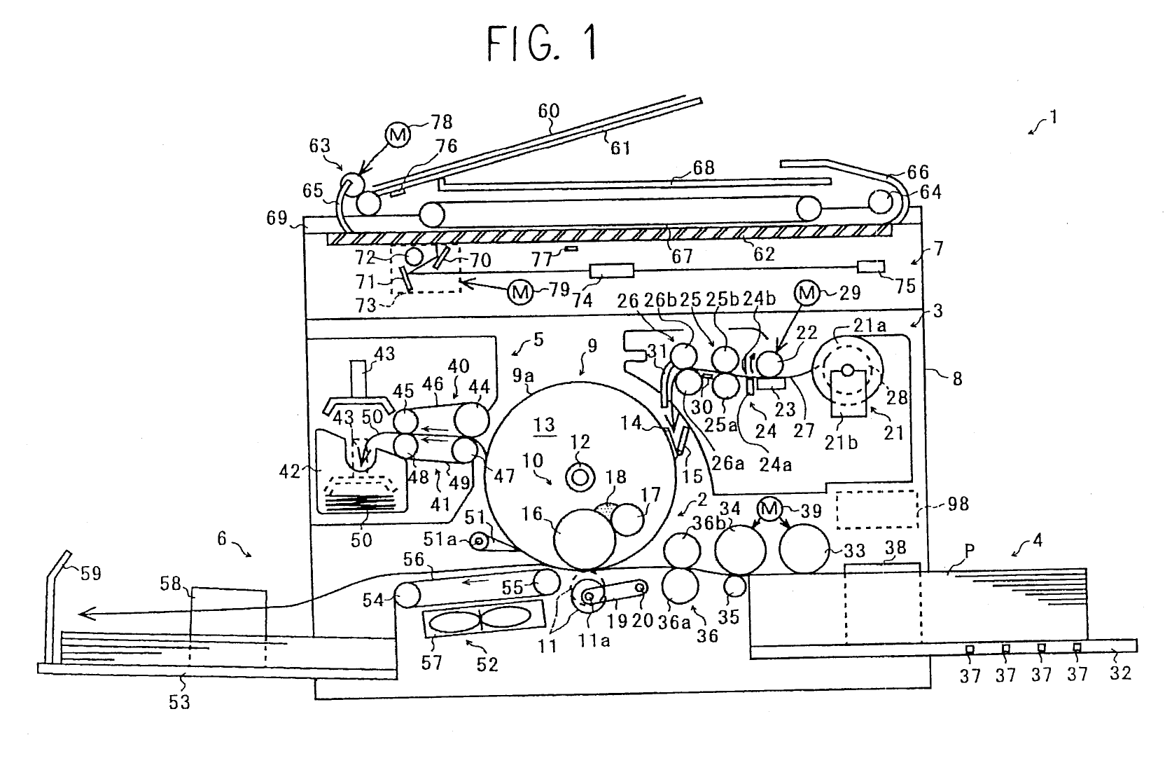

FIG. 1 shows the schematic structure of a printer 1 according to the present embodiment. The printer 1 is an example of stencil printer having an image division and printing function. In FIG. 1, the printer 1 includes a printing unit 2, a plate making unit 3, a sheet supply unit 4, a plate discharge unit 5, a sheet discharge unit 6, an image reading unit 7, and so on.

The printing unit 2 is disposed substantially in the center of the main body 8 of the apparatus, and includes a cylinder 9, ink supply means 10, a press roller 11, which is a pressure member, and so on.

The cylinder 9 includes mainly a pair of flanges 13 (only one shown in the drawings) rotatably supported by a support shaft 12 that also functions as an ink supply pipe, and a perforated support plate 9a wound around the outer periphery of each flange 13. The cylinder 9 is rotated in the clockwise direction by cylinder drive means that is not shown in FIG. 1. A plurality of small holes is formed in the surface of the support shaft 12 to supply ink to the ink supply means 10. Each flange 13 is rotatably supported by the support shaft 12 via bearings that are not shown in the drawings.

The perforated support plate 9a is formed from thin stainless steel sheet or the like. The perforated support plate 9a includes a perforated portion in which a plurality of holes is formed, and a non-perforated portion. The length in the circumferential direction of the perforated portion is formed to a length capable of printing an A3 size sheet. A stage portion 14 that has a plane parallel to the generating line of the cylinder 9 is disposed on the non-perforated portion. An openable clamper 15 that latches with the end of a master 27 that is described later is disposed on the top surface of the stage portion 14. Between one and three layers of mesh screen formed from fine strands of polyester or stainless steel or the like, which are not shown on the drawings, are wound on the outside of the perforated portion of the perforated support plate 9a.

The ink supply means 10 includes an ink roller 16 and a doctor roller 17 and so on, and is disposed in a position below the support shaft 12 within the cylinder 9. The ink roller 16 is rotatably supported between a pair of side plates, which is not shown on the drawings, that is fixed to the support shaft 12 between each flange 13. The ink roller 16 is rotated in the same direction as the cylinder 9 by drive means that is not shown on the drawings. The peripheral surface of the doctor roller 17 contacts the peripheral surface of the ink roller 16, and is rotatably supported between the side plates. The doctor roller 17 is rotated in the opposite direction to the ink roller 16 by drive means not shown in the drawings. At the contact area of the ink roller 16 and the doctor roller 17 a wedge shaped ink accumulation 18 is formed from the ink supplied from the support shaft 12. Also, an encoder that is not shown on the drawings is installed on the cylinder 9, that inputs positional information for the cylinder 9 to control means 98 that is described later.

The press roller 11 is disposed below the cylinder 9. The press roller 11 has virtually the same length in the axial direction as the cylinder 9, and is formed from a core 11a around which a rubber or similar elastic material is wound. The press roller 11 is rotatably supported at each end of the core 11a by an end of one of a pair of press roller arms 19. The pair of press roller arms 19 are plate shaped members. The other end of each of the press roller arms 19 is fixed to a press roller shaft 20 that is rotatably supported by the main body 8 of the apparatus. When swiveled by swiveling means, which is not shown in the drawings, the press roller shaft 20 and the press roller arms swivel as a unit. As a result of this swiveling action, the press roller 11 selectively occupies a position in which the outer periphery of the press roller 11 is separated from the outer periphery of the cylinder 9 as shown by the solid line, or a position in which the outer periphery of the press roller 11 presses against the outer periphery of the cylinder 9 with a predetermined pressure as shown by the broken line.

The plate making unit 3 is disposed in the top right of the printing unit 2. The plate making unit 3 is a unit that includes a master housing member 21, a platen roller 22, a thermal head 23, cutting means 24, master transport roller pairs 25, 26, and so on. The plate making unit 3 can be inserted into and removed from the main body 8 of the apparatus.

The master housing member 21 includes a pair of circular plate shaped master roll support members 21a and a pair of support members 21b. Each master roll support member 21a has a projection on each of its two sides. One of these projections from each of the two master roll support members 21a mates with a core of a master roll 28 around which the master 27 formed by applying a thermoplastic film to a porous support member is rolled. The other projection of each master roll support member 21a, which supports the master roll 28, is mated to a groove formed in one of the support members 21b. In this way, the master roll 28 is rotatably supported by the support members 21b.

The platen roller 22 and the thermal head 23 are disposed downstream of the master housing member 21 in the direction of transport of the master. The platen roller 22 is rotatably supported by side plates, which are not shown in the drawings, of the plate making unit 3. The platen roller 22 is rotated in the direction indicated by the arrow in FIG. 1 by a stepping motor 29 installed in the plate making unit 3.

The thermal head 23 has a plurality of thermal elements in the top surface thereof, and is installed on the side plates, which are not shown in the drawings, of the plate making unit 3. The top surface of the thermal head 23 is pressed with a predetermined pressure against the peripheral surface of the platen roller 22 by impelling means, which is not shown on the drawings. The thermal head 23 contacts the thermoplastic film side of the master 27, and the thermal elements are selectively heated to thermally stencil the master 27.

The cutting means 24 that cuts the master 27 is disposed downstream of the platen roller 22 and thermal head 23 in the direction of transport of the master 27. The cutting means 24 is a commonly known mechanism that includes a fixed blade 24a and a movable blade 24b, that cuts the master 27 by rotating the movable blade 24b with respect to the fixed blade 24a that is fixed with respect to the plate making unit 3.

The pairs of master transport rollers 25, 26 and master guide plates 30, 31 are disposed downstream of the cutting means 24 in the direction of transport of the master 27. Each pair of master transport rollers 25, 26 includes a drive roller 25a, 26a which are driven in mutual synchronization by drive means not shown in the drawings, and a driven roller 25b, 26b which are pressed against the drive rollers 25a, 26a respectively, by impelling means not shown in the drawings. Each drive roller 25a, 26a is provided with a clutch, which is not shown in the drawings, so that each drive roller 25a, 26a can be rotated by an externally applied force without applying a load to the drive means.

The master guide plate 30 is disposed between the two pairs of master transport rollers 25, 26, and the master guide plate 31 is disposed downstream of the pair of master transport rollers 26 in the direction of transport of the master 27. Each master guide plate 30, 31 is fixed to the side plates, which are not shown in the drawings, of the plate making unit 3. The master guide plates 30, 31 guide the master 27 transported by the pairs of master transport rollers 25, 26, and guide the leading edge of the master 27 to the outer peripheral surface of the cylinder 9.

The sheet supply unit 4 is disposed below the plate making unit 3. The sheet supply unit 4 includes a sheet supply tray 32, a sheet supply roller 33, a separation roller 34, a separation roller 35, a pair of registration rollers 36, and so on.

A plurality of sheets P is stacked on the top surface of the sheet supply tray 32. The sheet supply tray 32 is supported so as to be able to move in the vertical direction with respect to the main body 8 of the apparatus, and is moved vertically by elevating means, which is not shown in the drawings. The sheet supply tray 32 includes a plurality of sheet size detection sensors 37, which is sheet size detection means that detects the size of the stacked sheets P, and a pair of side fences 38 that guides the sheets P. Each sensor 37 includes reflection type sensors, and the side fences 38 are a commonly known structure that freely move in the sheet width direction that is at right angles to the sheet transport direction in synchronization with the sheet size detection sensors 37. In the present embodiment, the sheet size detection sensors 37 are configured to be able to detect the following fixed sizes: postcard portrait, A5 portrait, B5 portrait and landscape, A4 portrait and landscape, B4 landscape, and A3 landscape.

The sheet supply roller 33 has material with high frictional resistance on the surface thereof, and is disposed to the top of the sheet supply tray 32. The separation roller 34 also has material with high frictional resistance on the surface, and is disposed downstream of the sheet supply roller 33 in the direction of transport of the sheets. The sheet supply roller 33 presses against the sheets P in the sheet supply tray 32 with a predetermined pressure. The sheet supply roller 33 and the separation roller 34 are rotated in synchronization in the clockwise direction in FIG. 1 by a common stepping motor 39 via drive power transmission means such as gears or a belt, which is not shown in the drawings. The separation roller 35 is disposed to press against the separation roller 34 with a predetermined pressure, and is capable of intermittently rotating in the clockwise direction in FIG. 1.

The pair of registration rollers 36 is disposed downstream of the separation rollers 34, 35 in the direction of transport of the sheets. The pair of registration rollers 36 includes a drive roller 36a and a driven roller 36b. The drive roller 36a is rotated at a predetermined timing in synchronization with the cylinder 9 by a rotational drive force from cylinder rotation means, which is not shown in the drawings, transmitted by drive force transmission means, which is not shown in the drawings. The sheets P are transported towards the printing unit 2 by the drive roller 36a and the driven roller 36b that presses against the drive roller 36a.

The plate discharge unit 5 is disposed to the top left of the printing unit 2. The plate discharge unit 5 includes an upper plate discharge member 40, a lower plate discharge member 41, a plate discharge box 42, a compression plate 43, and so on.

The upper plate discharge member 40 includes a drive roller 44, a driven roller 45, an endless belt 46, and so on. The drive roller 44 is rotated by drive means, which is not shown in the drawings, in the clockwise direction in FIG. 1 so that the endless belt 46 moves in the direction of the arrow in FIG. 1. The lower plate discharge member 41 also includes a drive roller 47, a driven roller 48, an endless belt 49. The drive roller 47 is rotated in the clockwise direction in FIG. 1 by the drive force from the drive means, which is not shown in the drawings, that drives the drive roller 44, that is transmitted by drive force transmission means such as gears or a belt, which is not shown in the drawing. In this way, the endless belt 49 moves in the direction of the arrow shown in FIG. 1. Also, the lower plate discharge member 41 is structured to be capable of being selectively moved by a moving means, which is not shown in the drawings, to the position shown in FIG. 1, and to a position in which the endless belt 49 positioned on the outer periphery of the drive roller 47 contacts the outer peripheral surface of the cylinder 9.

The plate discharge box 42 houses used masters 50, and is capable of being inserted into and removed from the main body 8 of the apparatus. The compression plate 43 compresses used masters 50 brought into the plate discharge box 42 by the upper plate discharge member 40 and the lower plate discharge member 41. The compression plate 43 is moved in the vertical direction by elevating means that is not shown on the drawings between the positions indicated by the solid lines and by the broken lines in FIG. 1.

The sheet discharge unit 6 is disposed below the plate discharge unit 5. The sheet discharge unit 6 includes a separating claw 51, a sheet discharge transport member 52, a sheet discharge tray 53, and so on.

The separating claw 51 separates sheets P that have been printed from the outer peripheral surface of the cylinder 9. The separating claw 51 is supported by a support shaft 51a which is supported by side plates, which are not shown in the drawings, of the sheet discharge unit 6, so that the separating claw 51 can freely swivel. The tip of the separating claw 51 is selectively swiveled by swiveling means, which is not shown on the drawings, to a position in which the tip of the separating claw 51 is in contact with the outer peripheral surface of the cylinder 9, or a position in which the tip of the separating claw 51 will not interfere with obstacles such as the clamper 15 as a result of the rotation of the cylinder 9.

The sheet discharge transport member 52 includes a drive roller 54, a driven roller 55, endless belts 56, a suction fan 57, and so on. The drive roller 54 is rotatably supported by side plates of the unit, which are not shown in the drawings, and is driven by drive means, which is not shown in the drawings. The driven roller 55 is also rotatably supported by the same side plates. The endless belts 56 have a plurality of holes, and are fitted between the drive roller 54 and the driven roller 55. The suction fan 57 is disposed below the drive roller 54, the driven roller 55, and the endless belts 56, installed on the bottom surface of the main body of a unit, which is not shown in the drawings, having the shape of a case. The sheet discharge transport member 52 sucks the sheets P against the endless belt 56 by means of the suction force of the suction fan 57, and transports the sheets P by means of the rotation of the drive roller 54 in the direction of the arrow in FIG. 1.

Sheets P that have been printed are transported by the sheet discharge transport member 52 and stacked in the sheet discharge tray 53. The sheet discharge tray 53 includes a pair of side fences 58 that can freely move in the width direction of the sheets, and a single end fence 59 that can freely move in the transport direction of the sheets. The side fences 58 are a commonly known mechanism capable of moving in synchronization in the sheet width direction.

The image reading unit 7 is disposed to the top of the main body 8 of the apparatus. The image reading unit 7 includes a document loading platform 61 on which documents 60 are loaded, a contact glass 62 on which documents 60 are placed, a pair of document transport rollers 63 and a document transport roller 64 that transport documents 60, document guide plates 65, 66 that guide the transported documents 60, a plurality of document transport belts 67 that transport documents 60 along the contact glass 62, a document tray 68 that stacks documents 60 that have been read, a pressure plate 69 that supports all the abovementioned members except the contact glass 62 and that can be brought into contact with and separated from the contact glass 62, a scan unit 73 that includes reflection mirrors 70, 71 and a fluorescent light 72 for scanning and reading document images, a lens 74 that focuses the scanned image, an image sensor 75 having a CCD or similar that processes the focused images, and so on.

A document detection sensor 76 that detects the presence of documents 60 on the document loading platform 61 is disposed below the document loading platform 61. A document size detection sensor 77 that detects the presence and size of documents 60 on the contact glass 62 or transported documents 60 is disposed below the contact glass 62. In the present embodiment, the document size detection sensor 77 is configured to be able to detect the following fixed sizes: post card portrait, A5 portrait, B5 portrait and landscape, A4 portrait and landscape, B4 landscape, and A3 landscape. Also, the pair of document transport rollers 63 is driven by a stepping motor 78, and the scan unit 73 is driven by a stepping motor 79.

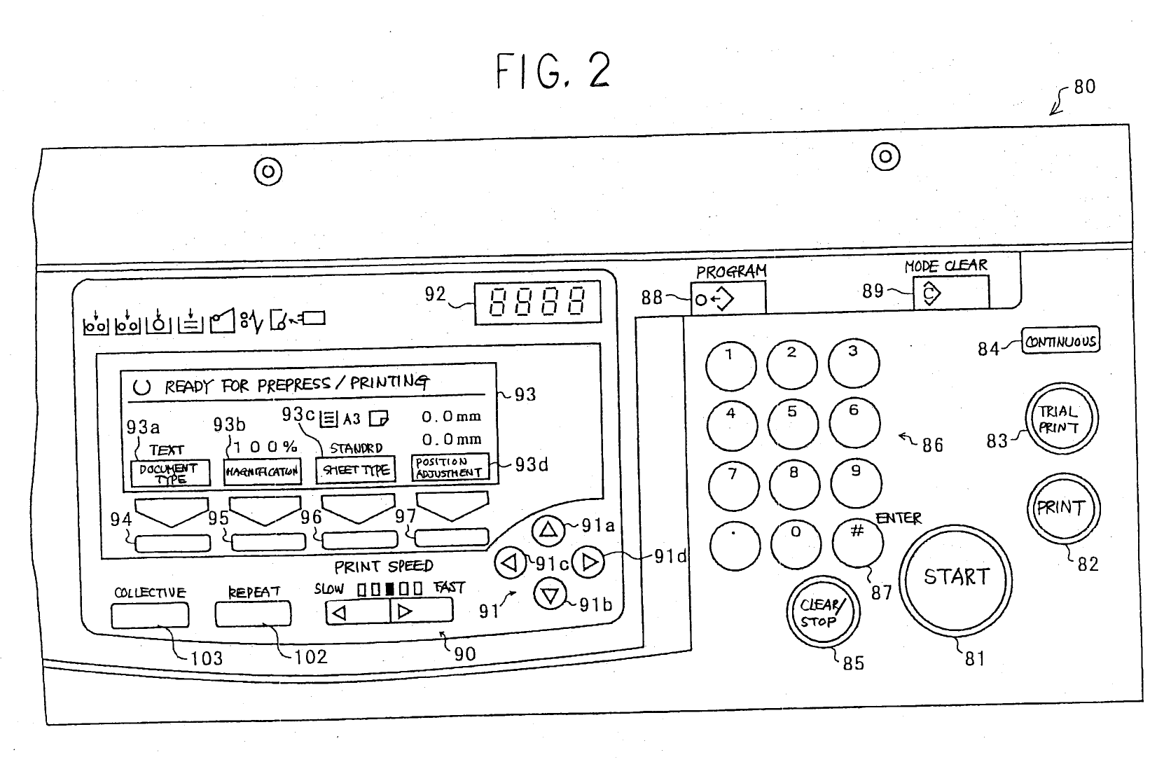

FIG. 2 shows the operation panel of the printer 1. An operation panel 80 is provided on the top and to the front of the main body 8 of the apparatus. The operation panel 80 includes on the top surface a prepress start key 81, a printing start key 82, a trial print key 83, a continuous key 84, a clear/stop key 85, a numerical keypad 86, an enter key 87, a program key 88, a mode clear key 89, a print speed setting key 90, a four-direction key 91, a display device 92 formed from seven segment LEDs, an LCD display device 93, a repeat key 102 for carrying out image division printing, a collective key 103, and so on.

The prepress start key 81 is pressed when the printer 1 carries out a prepress operation. After various prepress conditions are set, the prepress start key 81 is pressed, then after the plate discharge and image reading operations have been carried out, the prepress operation is carried out. Then the plate setting operation is carried out, and the printer 1 enters the standby state. The printing start key 82 is pressed to make the printer 1 carry out the printing operation. After the printer 1 is in the printing standby state and the various printing conditions have been set, the printing operation is carried out by pressing the printing start key 82. The trial print key 83 is pressed when carrying out a trial print. After the various printing conditions have been set, just one sheet is printed by pressing the trial print key 83. When the prepress and printing operations are carried out continuously, the continuous key 84 is pressed before pressing the prepress start key 81. After pressing the continuous key 84, the prepress conditions and the printing conditions are input, then the prepress start key 81 is pressed, and the printing operation is carried out after the plate discharge operation, the image reading operation, the prepress operation, and the plate setting operation.

The clear/stop key 85 is pressed to stop the operation of the printer 1, or to clear numbers that have been entered. The numerical keypad 86 is used for inputting numbers. The enter key 87 is pressed to confirm settings or numbers, and soon. The program key 88 is pressed when registering or calling up frequently used operations. The mode clear key 89 is pressed to clear the various modes and return to the initial state. The print speed setting key 90 is pressed to set the print speed prior to printing. For a denser image or when the ambient temperature is low, the printing speed is set slower, and for a lighter image or when the ambient temperature is high, the printing speed is set faster. The four-direction key 91 includes an up key 91a, a down key 91b, a left key 91c, and a right key 91d. The four-direction key 91 is pressed when, during editing of images, the position is adjusted, or when selecting numbers or items for each setting, and so on.

The display device 92 formed from seven segment LEDs mainly displays numbers for printing, and so on. The LCD display device 93 when in the initial state displays a document type setting display 93a, a magnification setting display 93b, a sheet type setting display 93c, and a position adjustment setting display 93d, as shown in FIG. 2. Selection setting keys 94, 95, 96, 97 are disposed below each display corresponding to each display respectively. The display device 93 has a layered structure. If the selection setting key 94 is pressed from the state shown in FIG. 2, the document type setting mode is set, in which the character mode and photograph mode and so on are set as the document image mode. If the selection setting key 95 is pressed from the state shown in FIG. 2, the magnification setting mode is set, in which automatic enlargement/reduction or independent enlargement/reduction and so on are selectively set. If the selection setting key 96 is pressed from the state shown in FIG. 2, the sheet type selection mode is set, in which standard sheets or thick sheets and so on, are set as the sheets to be used. If the selection setting key 97 is pressed from the state shown in FIG. 2, the position adjustment setting mode is set, in which the printing position is adjusted. The display in the display device 93 changes in accordance with each mode.

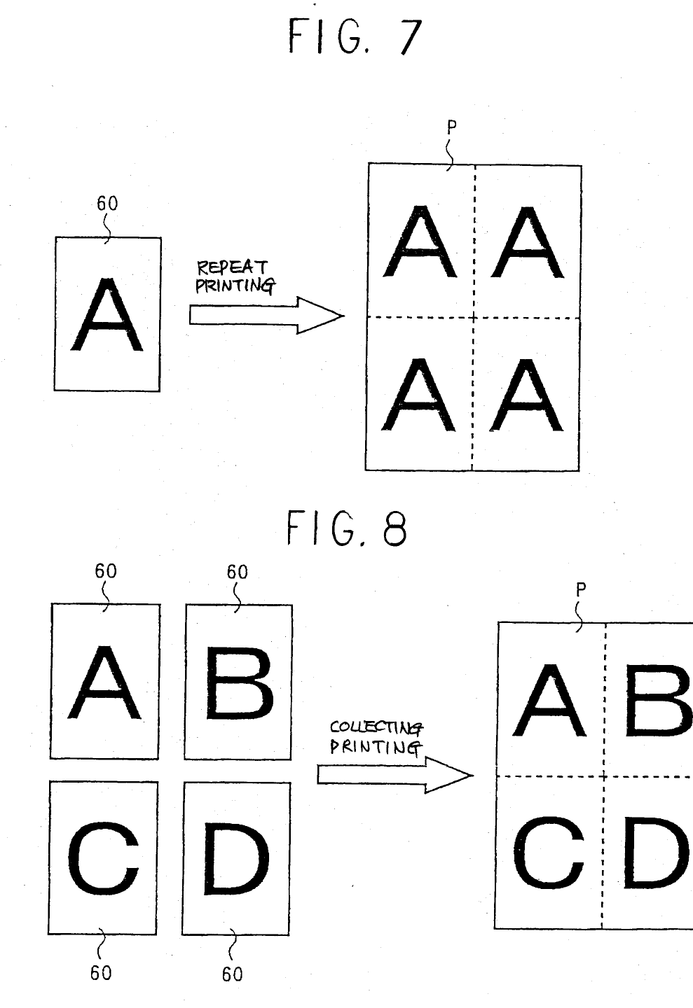

The repeat key 102 and the collective key 103 are pressed before the prepress start key 81 when carrying out image division printing. The repeat key 102 is pressed when carrying out repeat printing in which the image on one sheet of document 60 is formed a plurality of times on a single sheet P, as shown in FIG. 7. The collective key 103 is pressed when carrying out collective printing, in which images from a plurality of documents 60 are formed on a single sheet P, as shown in FIG. 8. In the examples shown in FIGS. 7 and 8, the document size is A5, the sheet size is A3, the number of divisions is four, and the magnification factor is 100%.

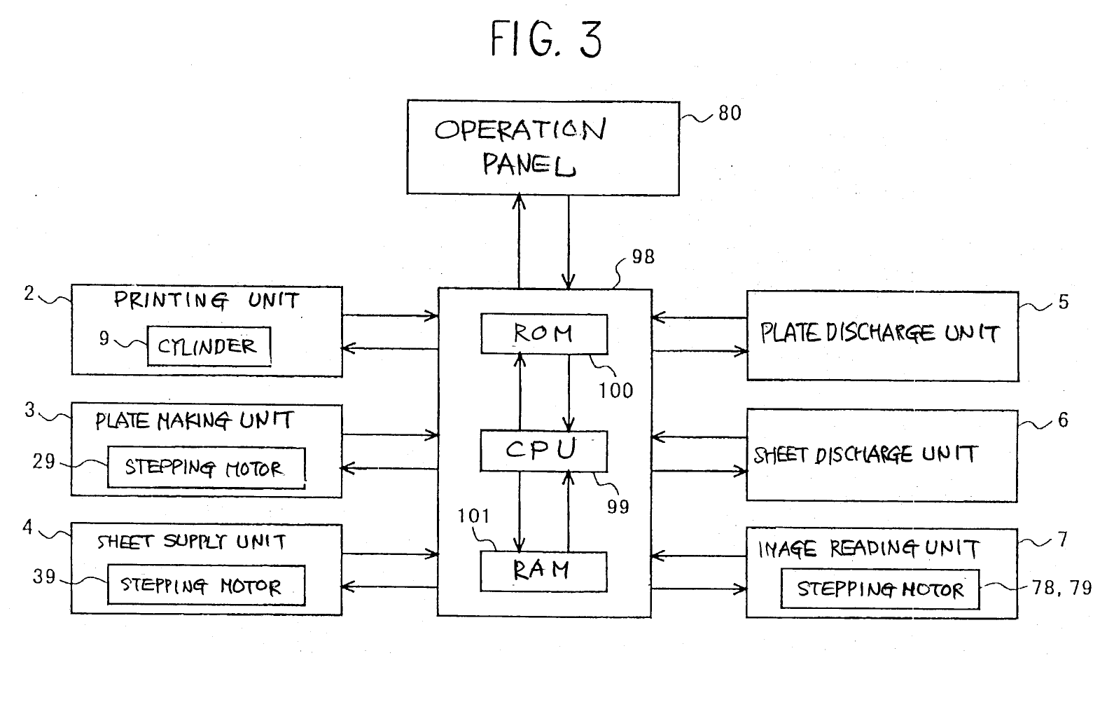

FIG. 3 shows an example of the structure of the control system used in the printer 1 of FIG. 1. Control means 98, which is a conventional microcomputer disposed within the main body 8 of the apparatus, includes a CPU 99, a ROM 100, a RAM 101, and soon. A program that operates the whole printer 1 is stored in the ROM 100. Prepress conditions such as document type or magnification factor, printing conditions such as the number of copies to be printed and the printing speed, and so on, are stored in the RAM 101.

Next, the operation of the printer 1 is explained based on the configuration described above. First, normal copying in which the repeat key 102 and the collective key 103 are not used is explained.

A document 60 is set on the contact glass 62, and after the various prepress conditions are set using each selection setting key 94, 95, 96, 97, the prepress start key 81 on the operation panel 80 is pressed. Then the cylinder drive means, which is not shown on the drawings, starts to rotate the cylinder 9 in the clockwise direction in FIG. 1. Then when the leading edge of the used master 50 wound on the cylinder 9 reaches the position corresponding to the drive roller 47, opening means, which is not shown on the drawings, operates and opens the clamper 15. Then the drive means, which is not shown on the drawings, operates and the lower plate discharge member 41 moves, the endless belt 49 on the outer peripheral surface of the drive roller 47 comes into contact with the leading edge of the used master 50 positioned on the non-perforated portion of the cylinder 9. The used master 50 is lifted up by the lower plate discharge member 41, and sandwiched and transported by the two plate discharge members 40, 41 by the rotation of the cylinder 9. After the transported used master 50 is housed in the plate discharge box 42, the used master 50 is compressed by the compression plate 43. When the plate discharge operation is finished, the cylinder 9 rotates until the clamper 15 is in the plate supply standby position on the rightmost side, and then stops. Then, the clamper 15 is opened by the opening means, which is not shown on the drawings, and the printer 1 is in the plate supply standby position.

When the plate discharge operation is finished, the scan unit 73 moves to the right in FIG. 1 and reads the image of the document 60. After the image that has been read is focused by the lens 74, the image is transmitted to the image sensor 75 and converted into an image data signal. The converted image signal is transmitted to a thermal head driver, which is not shown on the drawings, via the control means 98. When a document 60 is placed on the document loading platform 61, and the document 60 is detected by the document detection sensor 76, the pair of document transport rollers 63 and the document transport belt 67 operate, and the document 60 is brought onto the contact glass 62. Then the document size sensor 77 detects the size of the document 60, and the scan unit 73 moves as described above, and the image on the document 60 is read. The document 60 whose image has been read is transported from the contact glass 62 and discharged into the document tray 68 by the operation of the document transport belt 87 and the document transport roller 64.

After the printer 1 enters the plate supply standby state, the prepress operation is carried out. After the clamper 15 is opened, the stepping motor 29 is operated, the platen roller 22 is rotated, and a master 27 is drawn from the master roll 28. When the drawn master 27 passes the thermal head 23, the master 27 is selectively heated by the heating elements based on an operation signal from the thermal head driver, and the surface of the thermoplastic film is stenciled to make the plate. The stenciled master 27 is transported between the platen roller 22 and the pair of master transport rollers 25 with a predetermined tension force applied by the pair of master transport rollers 25 which are rotated with a peripheral velocity slightly larger than the peripheral velocity of the platen roller 22.

The control means 98 checks that the leading edge of the master 27, guided by the master guide plates 30, 31 and transported by the platen roller 22 and the pairs of master transport rollers 25, 26, has reached a predetermined position between the stage portion 14 and the clamper 15 from the number of steps of the stepping motor 29. Then the opening means, which is not shown in the drawings, is operated to close the clamper 15. The cylinder drive means is operated to start rotating the cylinder 9 again with a peripheral velocity that is virtually the same as the velocity of transport of the master 27. In this way the stenciled master 27 is wound around the cylinder 9. Also, when the control means 98 determines from the number of steps of the stepping motor 29 that one master 27 has been formed and transported, the cutting means 24 is operated and the master 27 is cut, and movement of the platen roller 22 and the pairs of master transport rollers 25, 26 is stopped. The cut master 27 is pulled from the plate making unit 3 by the rotation of the cylinder 9, and the winding operation is completed.

After completion of the winding operation, the sheet supply roller 33 and the separation roller 34 are rotated, and one sheet P is supplied from the sheet supply unit 4. At the same time the cylinder 9 is rotated at low speed in the clockwise direction in FIG. 1. When the leading edge of the supplied sheet P contacts the pair of registration rollers 36 the sheet temporarily stops. Then at a predetermined timing the sheet P is transported between the cylinder 9 and the press roller 11 by the rotation of the pair of registration rollers 36. When the sheet P reaches a predetermined position the press roller swivel means, which is not shown in the drawings, operates, and the press roller 11 presses against the outer peripheral surface of the cylinder 9 with a predetermined pressure. As a result of this pressure contact, the ink supplied to the interior surface of the cylinder 9 by the ink supply means 10 is transferred to the sheet P via the perforated portion of the cylinder 9, the porous portion of the mesh screen, which is not shown on the drawings, and the holes in the master 27. In addition, the porous support member of the master 27 becomes filled with ink, so the master 27 adheres closely to the outer peripheral surface of the cylinder 9. In this way what is known as plate setting is carried out.

After the ink is transferred onto the sheet P, the sheet P is separated from the outer peripheral surface of the cylinder 9 by the separating claw 51, and dropped onto the sheet discharge transport member 52. The printed sheet P delivered to the sheet discharge transport member 52 adheres to the endless belt 56 as a result of the suction force of the suction fan 57, and is transported to the left in FIG. 1 by the rotation of the drive roller 54, and discharged into the sheet discharge tray 53. As a result of this series of operations, the printer 1 completes the plate setting operation, and enters the print standby state.

After the printer 1 enters the print standby state, the printing conditions are set using the print speed setting key 90, and so on. Then the trial print key 83 on the operation panel 80 is pressed, and a trial print operation is carried out. When the trial print key 83 is pressed, the cylinder 9 is rotated with a peripheral velocity that corresponds to the set print speed in the clockwise direction in FIG. 1. In addition, the sheet supply roller 33 and the separation roller 34 rotate, and one sheet P is supplied from the sheet supply unit 4. After the timing is adjusted at the pair of registration rollers 36, the supplied sheet P is sent to the printing unit 2. There the sheet P is pressed against the outer peripheral surface of the cylinder 9 by the press roller 11, the same as during plate setting, and the image is transferred to the surface of the sheet P. The sheet P onto which the image was transferred is separated from the outer peripheral surface of the cylinder 9 by the separation claw 51, transported by the sheet discharge transport member 52, and discharged into the sheet discharge tray 53.

After confirming the image position, density, and so on by the trial print, the printing conditions are set using the numerical keypad 86, the print speed setting key 90, and so on. Then the printing start key 82 on the operation panel 80 is pressed, and the printing operation is carried out. When the printing start key 82 is pressed, the cylinder 9 is rotated with a peripheral velocity that corresponds to the set print speed in the clockwise direction in FIG. 1. In addition, the sheet supply roller 33 and the separation roller 34 rotate, and sheets P are continuously supplied from the sheet supply unit 4. The supplied sheets P are delivered to the printing unit 2 successively at predetermined timing, same as for the trial print. There the sheets P are pressed against the outer peripheral surface of the cylinder 9 by the press roller 11, the same as during the trial print, and the image is transferred to the surface of the sheet P. The discharged sheets are successively loaded into the sheet discharge tray 53. Then when the set number of prints has been completed, the operation of each unit is stopped, and the printer 1 again enters the print standby state.

Next, the operation when the repeat key 102 is pressed and image division printing is carried out is explained. The operator sets the sheets P in the sheet supply tray 32, sets the document 60 on the contact glass 62, then presses the repeat key 102, and presses the selection setting key 95 to set the magnification factor.

After setting the magnification factor, the prepress conditions are set for the prepress mode, and so on. Then the prepress start key 81 is pressed, and the plate discharge operation is carried out as described above. When the printer 1 enters the plate supply standby state, the plate making operation is carried out. The control means 98 calculates the image area to be read from the document size and the magnification factor, and repeats the calculated image area to fill the sheet size, and carries out the prepress operation. In this way, repeated images are formed on the master 27.

Thereafter, the plate setting operation is carried out as described above. After the plate setting operation is completed the printing conditions are set, and the print start key 82 is pressed. Then sheets P are continuously supplied from the sheet supply unit 4 and the printing operation is carried out as described above. When the set number of prints has been output, the printer 1 again enters the print standby state.

When carrying out the repeat printing as described above, the size of the document 60 is automatically detected by the document size detection sensor 77. However, the sizes of the document 60 that can be detected by the document size detection sensor 77 are fixed shapes. Therefore, if the document 60 has an irregular size, the size is recognized as a regular size that is larger than the size of the document 60. Therefore, the expected image cannot be obtained. For example, to do repeat printing on a document 60 whose size is half postcard size, the document 60 size is recognized as postcard size, so there is the problem that although eight images can be printed on an A4 sheet P, only four images are printed.

Therefore, in the printer according to the present embodiment, image size input means is provided to input the size of the image that is read, regardless of the size of the document 60. The following is an explanation of the image division printing operation using the image size input means.

When the operator presses the repeat key 102, a screen is displayed in the display device 93 for selecting whether the size of the document 60 is regular or irregular. Then the operator selects whether the size of the document 60 is regular or irregular, and presses the corresponding selection setting key. When a regular size is selected, the operation is the same as described above.

When an irregular size is selected, a screen for inputting the image size is displayed in the display device 93. After the operator has entered the image size in the vertical direction and the horizontal direction using the numerical keypad 86, the selection setting key is pressed. In this way, the image size is set, and the set image size is stored in the RAM 101. During this setting, numerical keypad 86 functions as the image size input means. The image size set at this time may be, for example, the size from an origin set in the top left corner of the contact glass 62.

After the image size is set, the magnification factor is set as described above. Then the control means 98 calculates the number of image surfaces in repeat printing from the set image size and the magnification factor, and the images are automatically arranged. At this time, there is a function that if, for example, the size of the sheet P is A4 portrait, but the image is longer in the horizontal direction than in the vertical direction, the image is arranged by being rotated through 90 degrees. Also, a function is provided that carries out a 180 degree rotation process or a centering process on repeat images as described later, to take account of problems such as clipping of the images on the leading edge as a result of the margin on the leading edge of the sheet during printing.

The prepress operation is carried out based on this arrangement, and the plate supply operation and the plate setting operation are carried out as described above, and the printer 1 enters the print standby state. Then, the various printing conditions are set, the printing start key 82 is pressed, and the printing operation is carried out as described above.

The above is an explanation of an example of a printer with the image division printing function, but the following is an explanation of an example of a printer with double-sided printing function.

### Embodiment 2

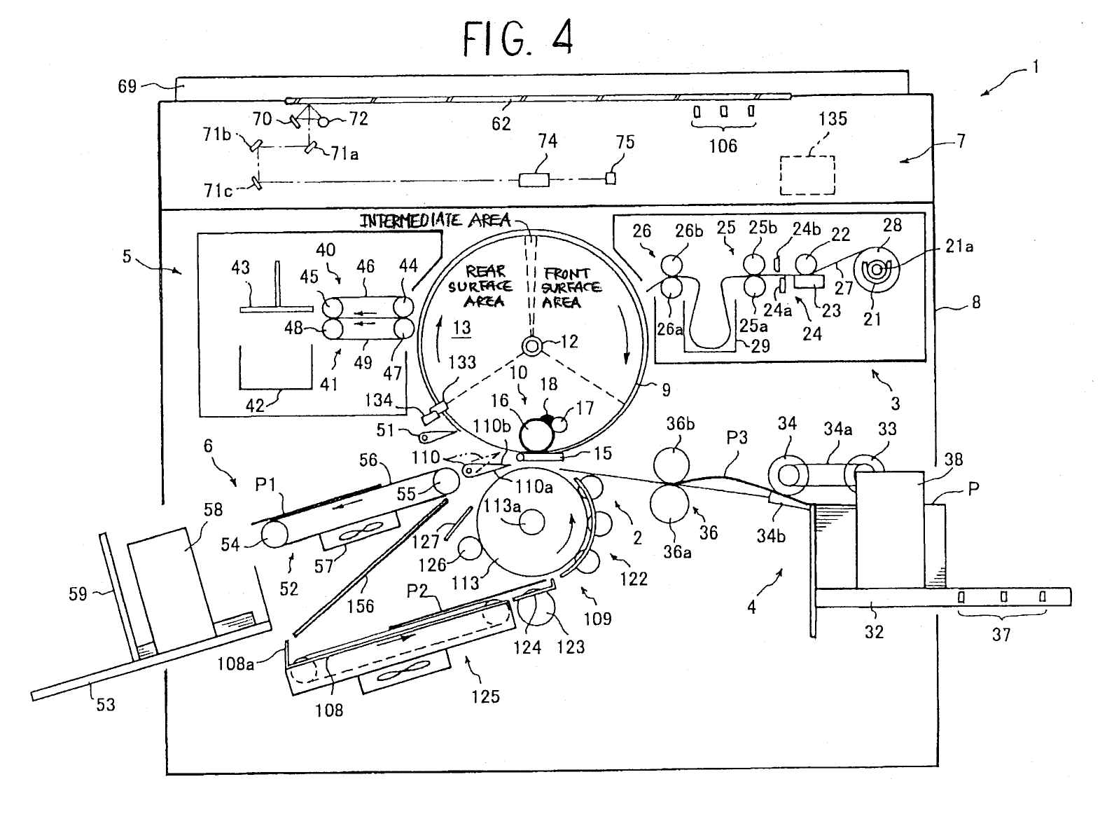

FIG. 4 shows the schematic structure of a printer according to the present embodiment, showing an example of a stencil printer having a double-sided printing function.

In this figure, the printer 1 includes a printing unit 2, a plate making unit 3, a sheet supply unit 4, a plate discharge unit 5, a sheet discharge unit 6, and a reading unit 7. The basic structure is substantially the same as the printer described in FIG. 1, and the same members are given the same reference numerals. Also, the image division printing function is provided, as stated previously. The points of difference from the previously described printer are that an auxiliary tray 108, sheet re-supply means 109, a switching member 110, and so on, are added.

The printing unit 2, which is disposed in approximately the center of the main body 8 of the apparatus, includes a cylinder 9 and a press roller 113 as pressure means. The cylinder 9 can be inserted into and removed from the main body 8 of the apparatus, is rotatably supported, and is rotated by cylinder drive means, which is not shown on the drawings. The cylinder 9 includes a clamper 15 that can be opened and closed on the outer peripheral surface. When carrying out double-sided printing a divided plate master made in the plate making unit 3 is wound around the outer peripheral surface of the cylinder 9. When carrying out single sided printing a plate master made in the plate making unit 3 is wound around the outer peripheral surface of the cylinder 9.

An ink supply means 10 that includes an ink roller 16, a doctor roller 17, and so on, is disposed in the area below a support shaft 12 inside the cylinder 9. The ink roller 16 is rotatably supported by a pair of side plates, which is not shown on the drawings, fixed to the support shaft 12 between flanges 13. The ink roller 16 is rotated by drive means, which is not shown on the drawings, in the same direction as the cylinder 9. The peripheral surface of the doctor roller 17 contacts the peripheral surface of the ink roller 16, and is rotatably supported between the side plates. The doctor roller 17 is rotated by drive means, which is not shown on the drawings, in the opposite direction to the ink roller 16. At the contact area of the ink roller 16 and the doctor roller 17 a wedge shaped ink accumulation 18 is formed from the ink supplied from the support shaft 12. Also, a rotary encoder, which is not shown in the drawings, that detects the position of the cylinder 9, or a home position sensor 134 that detects the home position by detecting a dog 133 installed on the cylinder 9 is provided near the peripheral surface of the cylinder 9. In the present embodiment, a plate master 15 capable of printing a maximum A3 size sheet is wound around the cylinder 9.

When carrying out double-sided printing, a first plate image corresponding to the image on the front surface and a second plate image corresponding to the image on the rear surface are formed on the divided plate master made in the plate making unit 3, with a portion without an image formed between the plate images. The divided plate master is wound around the cylinder 9 with the first plate image corresponding to the front surface area shown in FIG. 4, the second plate image corresponding to the rear surface area shown in FIG. 4, and the portion with no image corresponding to the intermediate area shown in FIG. 4. In the present embodiment, a maximum A4 portrait (with the short side direction of the sheet as the direction of transport of the sheet) sized sheet can be printed in the first plate image and the second plate image respectively.

Also, when printing on a single side, a third plate image is formed on the plate master made in the plate making unit 3 corresponding to the single-sided print image. The plate master is wound around the cylinder 9 with the third plate image corresponding to the total area within the front surface area, the rear surface area, and the intermediate area shown on FIG. 4. In the present embodiment, the third plate image is formed so that a maximum A3 sized sheet can be printed.

The press roller 113, which is a pressure member, is disposed below the cylinder 9. The press roller 113 is made from an elastic material having water repellant properties, such as a fluorine resin or the like. The press roller 113 is rotatably supported at both ends by arm members, which are not shown on the drawings. The arm members, which are not shown on the drawings, are supported so that they can be swiveled by swiveling means, which is not shown on the drawings. The press roller 113 can selectively be positioned in a separated position and a pressure contact position. The separated position is the position shown in FIG. 4 in which the peripheral surface of the press roller 113 is separated from the cylinder 9. The pressure contact position is a position in which the peripheral surface of the press roller 113 presses against the divided plate master on the peripheral surface of the cylinder 9.

The swiveling means, which is not shown on the drawings, is configured so that the area that the press roller 113 presses against the cylinder 9 can be switched to either of a first area that includes all of the front surface area, the intermediate area, and the rear surface area, a second area that is an area that is the same as the front surface area, and a third area that includes the downstream portion of the front surface area, the intermediate area, and the rear surface area shown in FIG. 1. A screening roller 126 is disposed near the peripheral surface of the press roller 113, that contacts the peripheral surface of the press roller 113, and carries out screening. The screening roller 126 is rotated by drive means, which is not shown on the drawings.

A sheet re-supply guide member 122 is disposed to the right near the press roller 113 to transport sheets P that have been printed on the front surface transmitted from the sheet re-supply means 109 along the peripheral surface of the press roller 113. A sheet re-supply registration roller 124 is disposed below the press roller 113 to transmit sheets P stored in the auxiliary tray 108 to contact the peripheral surface of the press roller 113. A sheet re-supply transport unit 125 is disposed to the bottom left of the press roller 113 having the auxiliary tray 108 on the top surface thereof. This is provided integral with a sheet re-supply position determining member 124. A movable sheet retention plate 108a is disposed along the top surface of the auxiliary tray 108 on top of the sheet re-supply transport unit 125. The sheet re-supply means 109 includes the auxiliary tray 108, the sheet re-supply guide member 122, the sheet re-supply registration roller 123, the sheet re-supply position determining member 124, the sheet re-supply transport unit 125, and the sheet retention plate 108a.

The switching member 110 is disposed to the left of the contact position of the cylinder 9 and press roller 113 on the transport path of the sheets P. The switching member 110 is rotatably supported by the main body 8 of the apparatus at the downstream end in the direction of transport of the sheets. The switching member 110 is moved by moving means, which is not shown on the drawings, selectively to a first position indicated by the solid lines in FIG. 4, or a second position indicated by the two-dot chain lines in FIG. 4. When the switching member 110 is in the first position, sheets that have passed between the cylinder 9 and the press roller 113 are guided to the sheet discharge unit 6. When the switching member 110 is in the second position, sheets that have passed between the cylinder 9 and the press roller 113 are guided to the auxiliary tray 108.

The plate making unit 3 is disposed to the top right of the printing unit 2. As in FIG. 1, the plate making unit 3 includes a master support member 21 that supports a master roll 28 formed from masters 27 wound in a roll shape, a platen roller 22, a thermal head 23, master cutting means 24, a master stock unit 29, a pair of tension rollers 25, a pair of reversal rollers 26, and so on. During double-sided printing division plate masters are made and during single-sided printing plate masters are made in the plate making unit 3.

A sheet supply unit 4 is disposed below the plate making unit 3. The sheet supply unit 4 includes a sheet supply tray 32 in which sheets P are loaded, a sheet supply roller 33, a separation roller 34, a separation pad 34b, a pair of registration rollers 36, and so on, the same as in FIG. 1. A plurality of sheet size detection sensors 37 is disposed in the sheet supply tray 32 to detect the size of the sheets P loaded on the top surface of the sheet supply tray 32.

A plate discharge unit 5 is disposed to the top left of the printing unit 2. The plate discharge unit 5 includes an upper plate discharge member 40, a lower plate discharge member 41, a plate discharge box 42, a compression plate 43, and so on, the same as in FIG. 1. Used division plate masters and used plate masters are separated from the outer peripheral surface of the cylinder 9, and disposed within the plate discharge box 42.

A sheet discharge unit 6 is disposed below the plate discharge unit 5. The sheet discharge unit 6 includes a separation claw 51, a sheet discharge transport unit 52, a sheet discharge tray 53, a suction fan 57, and so on, the same as in FIG. 1. Sheets Pare separated from the peripheral surface of the cylinder 9, and discharged to the sheet discharge tray 53.

An image reading unit 7 is disposed in the top of the main body 8 of the apparatus. The image reading unit 7 includes a contact glass 62 on which documents are loaded, a pressure plate or an ADF 69 that can either contact or be separated from the contact glass 62, reflection mirrors 70, 71a, 71b, 71c that scan and read the document images, a fluorescent light 72, a lens 74 that focuses the scanned image, an image sensor 75 that processes the focused image, and so on, the same as in FIG. 1.

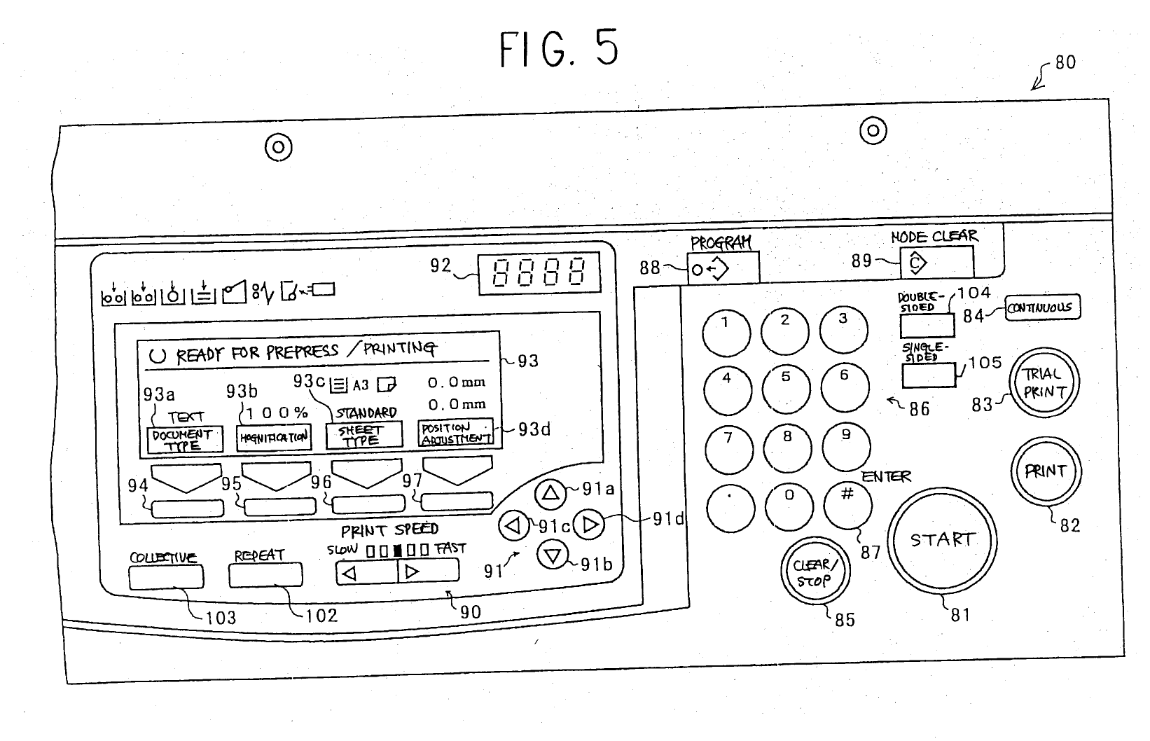

FIG. 5 shows an operation panel 80 of the printer 1. The structure of the operation panel 80 is the same as that in FIG. 2, as explained already. However, in the embodiment of FIG. 5, a double-sided printing key 104 that is pressed when carrying out double-sided printing, and a single-sided printing key 105 that is pressed when carrying out single-sided printing are provided.

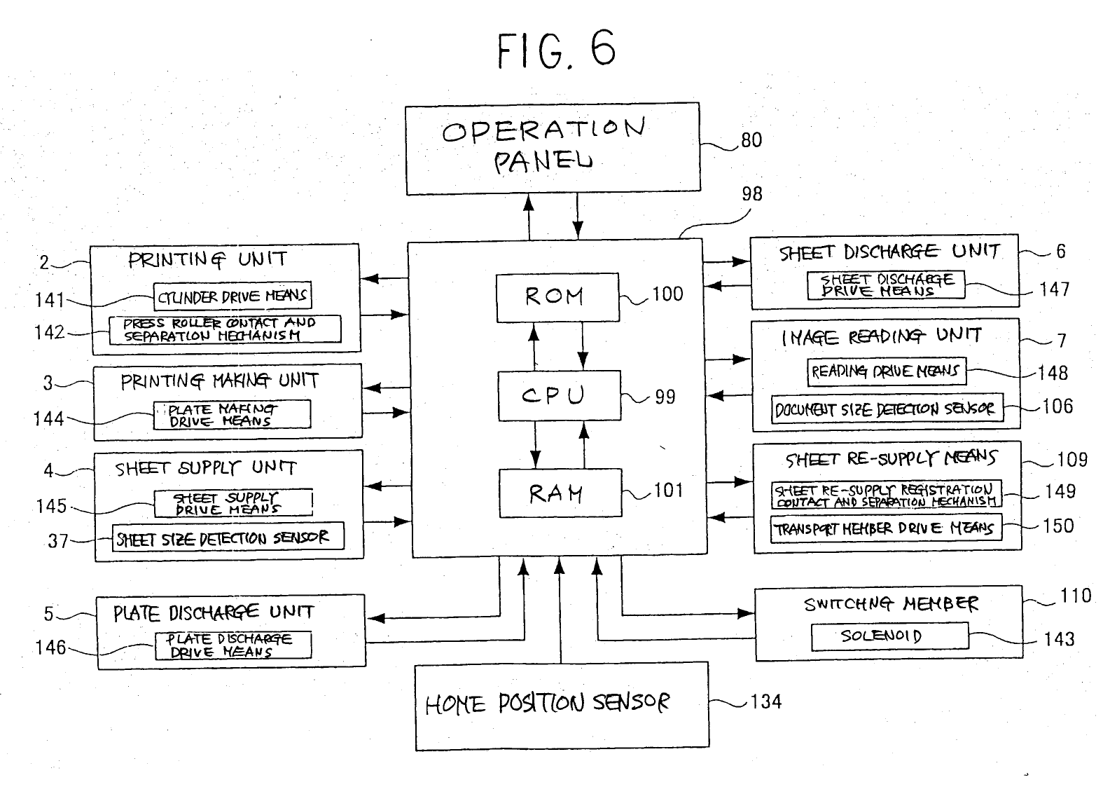

FIG. 6 shows an example of the configuration of the control system used in the printer 1 of FIG. 4. In this figure, control means 98 is a commonly known microcomputer that includes internally a CPU 99, a ROM 100, a RAM 101, provided within the main body 8 of the printer.

The CPU 99 controls the overall operation of the printer 1, by controlling the operation of drive means 141, 144, 145, 146, 147, 148 provided in the control unit 2, the plate making unit 3, the sheet supply unit 4, the plate discharge unit 5, the sheet discharge unit 6, the image reading unit 7, a sheet re-supply registration separation mechanism 149 and a transport member drive motor 150 provided in the sheet re-supply means 109, a solenoid 143 that operates the switching member 110, and so on. The control carried out by the CPU 99 is based on various signals from the operation panel 80, measurement signals from the various sensors provided in the main body 8 of the printer 1, and an operation program called up from the ROM 100. The program that operates the overall printer 1 is stored in the ROM 100, and this program is called up as appropriate by the CPU 99. The RAM 101 has the function of temporarily storing the calculation results of the CPU 99, and the function of storing at anytime, settings and data signals input from each key on the operation panel 80 and from the various sensors, and ON and OFF signals. Also, the control means 98 determines the position of the cylinder 9 based on a home position signal from the home position sensor 134, and a signal from the rotary encoder, which is not shown on the drawings, provided in the cylinder drive means 141. Also, the control means 98 has a function of storing the size of the first and second plate images formed on division plate masters.

The following is an explanation of the operation of the printer 1 when the double-sided printing key 104 is pressed, and double-sided printing is carried out, based on the configuration as described above.

A document is set in the image reading unit 7, and the operator presses the double-sided printing key 104. The double-sided printing setting is stored in the control means 98, and the operation program for double-sided printing is called up. Then the operator presses the prepress start key 81, and the operation of reading the document image is carried out in the image reading unit 7. In addition the plate discharge unit 5 is operated, and the used division plate master or the used plate master on the outer peripheral surface of the cylinder 9 is removed. After discharging the plate, the plate making unit 3 is operated, the first plate image and the second plate image are formed on the master 27 to create a new division plate master, and the division plate master is wound around the cylinder 9.

After the winding operation is completed, and the printer 1 has entered the double-sided printing standby state, the various printing conditions are set, and the printing start key 82 is pressed by the operator. The cylinder 9 is rotated at a set velocity, and the first sheet P1 is separated and supplied from the sheet supply unit 4. The supplied sheet P1 stops temporarily at the pair of registration rollers 36, and at a predetermined timing is fed between the cylinder 9 and the press roller 113. Setting the printing conditions may be carried out prior to pressing the prepress start key 81.

The cylinder 9 rotates through a predetermined angle until the front surface area occupies a predetermined position corresponding to the press roller 113. Then the press roller 113 occupies the pressure contact position, and sheet P1 is pressed against the first plate image of the division plate master on the cylinder 9, and the front surface image is transferred onto the surface of the sheet P1. At this time, the swiveling means (which is not shown on the drawings) that swivels the press roller 113 is set so that the pressure area of the press roller 113 with respect to the cylinder 9 is the second area.

The sheet P1 on which the front surface printing is completed is separated from the outer peripheral surface of the cylinder 9 by the leading edge of the switching member 110 which is in the second position. The sheet P1 is guided by the guide plates 127, 156, and fed to the sheet re-supply transport unit 125. At this time, the leading edge of the sheet P1 is stopped by the sheet retention plate 108a, and loaded in the auxiliary tray 108 from the trailing edge side. The sheet P1 in the auxiliary tray 108 is transported in the direction of the arrow in FIG. 4 by the sheet re-supply transport unit 125, and when the leading edge of the sheet P1 contacts the sheet re-supply position determining member 124, the sheet P1 stops temporarily.

While the first sheet P1 is being guided to the auxiliary tray 108, the cylinder 9 continues to rotate, and a second sheet P2 is supplied from the sheet supply unit 4 at the same timing as the first sheet P1. At this time, the swiveling means, which is not shown on the drawings, is set so that the pressure area of the press roller 113 with respect to the cylinder 9 is the first area. The front surface image is transferred to the front surface of the supplied second sheet P2 by the press roller 113 in the same way as the first sheet P1. Then the second sheet P2 is fed to the sheet re-supply transport unit 125 by the switching member 110 which occupies the second position.

After the second sheet P2 is supplied from the sheet supply unit 4, the sheet re-supply registration roller 123 operates. Then the first sheet P1 that is stored in the auxiliary tray 108 is pressed against the press roller 113, at a timing that is slightly earlier than the timing that the rear surface area of the cylinder 9 arrives at the position corresponding to the press roller 113. The first sheet P1 that is pressed against the peripheral surface of the press roller 113 is brought into contact with the cylinder 9 by the rotational force of the press roller 113 which is driven by the pressure contact with the cylinder 9. Then the rear surface image is transferred to the rear surface of the sheet P1 by being pressed against the second plate image of the division plate master.

The first sheet P1, onto which the rear surface image was transferred so that the double-sided printing is finished, is guided to the sheet discharge unit 6 by the switching member 110 that occupies the first position. The leading edge of the separation claw 51 separates the sheet P1 from the outer peripheral surface of the cylinder 9. The separated sheet P1 on which the printing is finished is fed to the sheet discharge transport unit 52, and discharged into the discharge tray 53. Next, the third sheet P3 is supplied in the same way, and the operation as described above is carried out. Thereafter the operation is repeated until the set number of sheets have been consumed. After the final sheet P has been guided to the auxiliary tray 108, the swiveling means, which is not shown on the drawings, is set so that the pressure area of the press roller 113 with respect to the cylinder 9 is the third area. When the double-sided printing operation for the set number of sheets is completed, the operation of each unit is stopped.

Next, the operation of the printer 1 when the single-sided printing key 105 is pressed and single-sided printing is carried out is explained.

The document is set in the image reading unit 7, and the operator presses the single-sided printing key 105. Then the single-sided printing setting is stored in the control means 98, and the operation program for single-sided printing is called up. Then when the operator presses the prepress start key 81, the document image reading operation is carried out in the image reading unit 7. In addition the plate discharge unit 5 is operated, and the used division plate master or the used plate master is separated from the outer peripheral surface of the cylinder 9. After the plate has been discharged, a third plate image is formed on the master 27 by the operation of the plate making unit 3, so that a new plate master is made and wound around the cylinder 9.

When the plate winding operation is finished, the printer 1 enters the single-sided printing standby state. Then the various printing conditions are set, and the operator presses the printing start key 82. The cylinder 9 is rotated at a set velocity, and at the same time a single sheet P is separated and supplied from the sheet supply unit 4. The supplied sheet P stops temporarily at the pair of registration rollers 36, and then at a predetermined timing is fed between the cylinder 9 and the press roller 113.

The cylinder 9 rotates through a predetermined angle until the front surface area occupies a position corresponding to the press roller 113. Then the press roller 113 occupies the pressure contact position, and the sheet P is pressed against the third plate image of the plate master on the cylinder 9, and the image is transferred. At this time, the swiveling means (which is not shown on the drawings) that swivels the press roller 113 is set so that the pressure area of the press roller 113 with respect to the cylinder 9 is the first area.

The sheet P onto which the image was transferred and for which printing is finished, is guided to the sheet discharge unit 6 by the switching member 110 that occupies the first position. The sheet P is separated from the outer peripheral surface of the cylinder 9 by the leading edge of the separation claw 51. The separated printed sheet P is fed to the sheet discharge unit 52, and discharged and loaded into the sheet discharge tray 53. Then the operation described above is repeated until the set number of sheets have been consumed. When the printing operation of the set number of single-sided sheets is finished, the operation of each unit is stopped.

The operation during single-sided printing described above is the same as for the printer according to the first embodiment shown in FIGS. 1 through 3. Also, the operation in repeat printing using the image division printing function is the same as the operation in the first embodiment described above. However, the printer with the structure shown in FIG. 4 can carry out repeat printing on both the front surface and the rear surface of sheets.

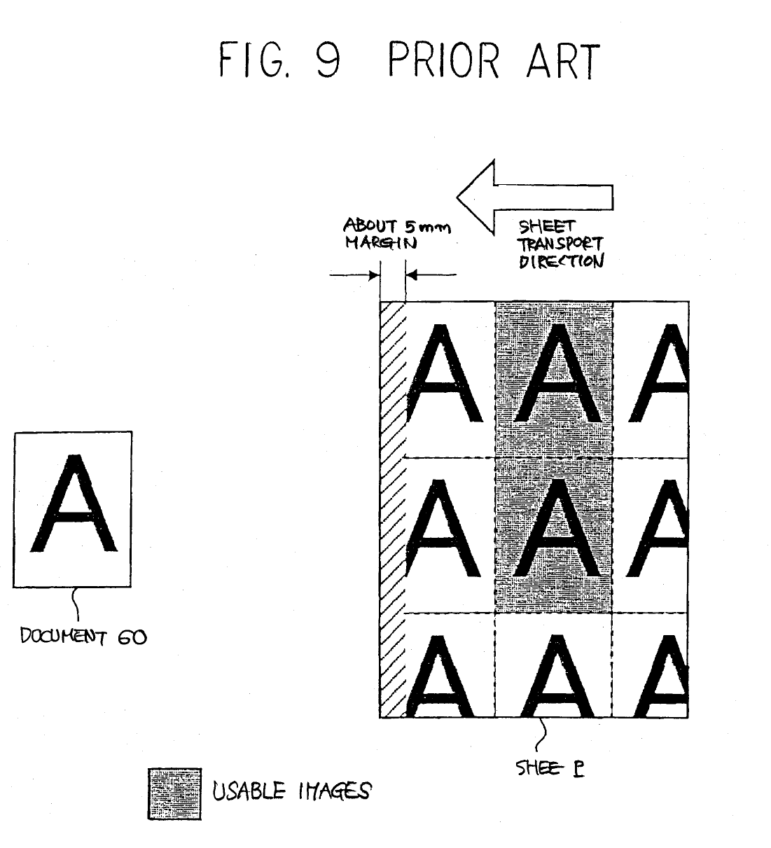

The printer 1 according to the first or second embodiment (FIG. 1 or FIG. 4) as explained above has the function of carrying out repeat processing in which the image of the same document is formed a plurality of times, as the image division printing function. However, to separate the sheet P from the master wound around the cylinder 9, there is a portion of up to 5 mm at the leading edge of the sheet on which no image is transferred. Therefore, as shown in FIG. 9, if the image of a document 60 having no margin on the leading edge is read, a plate is made, and repeat printing is carried out, a blank portion (margin) of up to 5 mm on which no image is transferred is formed on the leading edge of the sheet P in the direction of transport of the sheet. Therefore, when repeat printing is carried out and a plurality of images is formed on the sheets P, only some of the printed images are usable images (the part shaded in the figure), so the printing is wasteful.

Also, in the printer with the double-sided printing function shown in FIG. 4, when double-sided printing is carried out using the repeat function, the standard position with respect to the sheet is different on the front surface and the rear surface of the printed sheet P. Therefore, there is the problem that the image positions front and rear do not coincide, but are shifted relative to each other, either vertically or horizontally.

Therefore, in the present invention, to solve this type of problem the following measures are adopted.

(1) When carrying out repeat printing, the repeat image data is rotated through 180 degrees, and the plate is made, to reduce the number of images that cannot be used because of the clipped image at the leading edge of the sheet.

(2) When carrying out repeat printing on both sides of a sheet, the double-sided plate making and printing is carried out on images for which a centering process was carried out on the repeat image data, so that the printing positions can be aligned on the front and rear.

(3) The number of image surfaces that can be repeat printed is calculated from the length in the main scanning direction of the repeat document and the length in the main scanning direction of the print sheet. From their total length and the length of the print sheet in the main scanning direction, a centering process in the main scanning direction is carried out, and when carrying out double-sided printing, the print position is aligned front and rear for opening vertically.

(4) For double-sided printing, when making the plate for the rear surface, the length of the image protruding from the trailing edge when making the plate from the front edge is calculated. Then by shifting the rear surface plate start position in the sub scanning direction by this amount and outputting the image, it is possible to align the printing positions front and rear in double-sided printing for left to right opening.

(5) The number of image surfaces that can be repeated on the print sheet is calculated from the length in the main scanning direction of the repeat document, the length in the main scanning direction of the print sheet, the length in the sub scanning direction of the repeat document, and the length in the sub scanning direction of the print sheet. A centering process is carried out on the images that have been repeat processed for this number of surfaces. Then when double-sided printing is carried out, the print position is aligned front and rear for left to right opening, and also the number of unusable images due to loss of image at the leading edge of the sheet is reduced.

The following are explanations of specific examples of the present invention.

### EXAMPLE 1

The printer explained in the first embodiment and the printer explained in the second embodiment have image size input means for inputting the length of the document image in the main scanning direction and in the sub scanning direction, and sheet size detection means 37 that detect the size of sheets P. When the image division printing function is used (in particular the repeat printing function), the control means 98 has a function in which the print image corresponding to the document image formed on the sheet is arranged by being rotated through 180 degrees.

For example, when the operator presses the repeat key 102, a screen for selecting whether the size of the document 60 is regular or irregular is displayed in the display device 93. Then the operator selects whether the size of the document 60 is regular or irregular, and presses the corresponding selection key. If a regular size is selected, a screen for selecting regular size is displayed. Also, if an irregular size is selected, a screen for inputting the image size is displayed in the display device 93. Therefore, the operator enters the image size in the vertical direction and the horizontal direction by pressing the numerical keypad 86, and presses the selection setting key. In this way the image size is set, and the set image size is stored in the RAM 101. During this setting operation the numerical keypad 86 functions as image size input means. The image size set at this time is for example the size from an origin set in the top left corner of the contact glass 62.

After the image size has been set, the magnification factor is set. Then the control means 98 calculates the number of image surfaces in repeat printing from the set image size, magnification factor, and sheet size detected by the sheet size detection means, and automatically arranges the images. At this time, if it is determined that a part of the image will be lost as a result of the leading edge margin, the image is arranged by being rotated through 180 degrees.

The plate making operation is carried out based on this arrangement. Then the plate supply operation and the plate setting operation is carried as explained for the operation of the first or second embodiment. Then, the various printing conditions are set, the printing start key 82 is pressed, and the repeat printing operation is carried out.

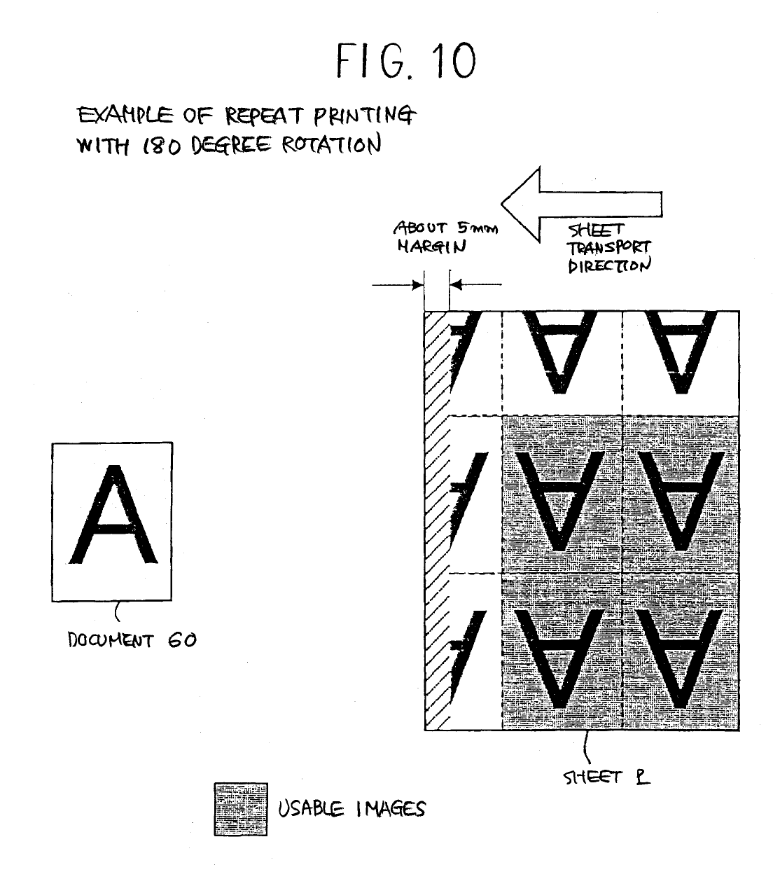

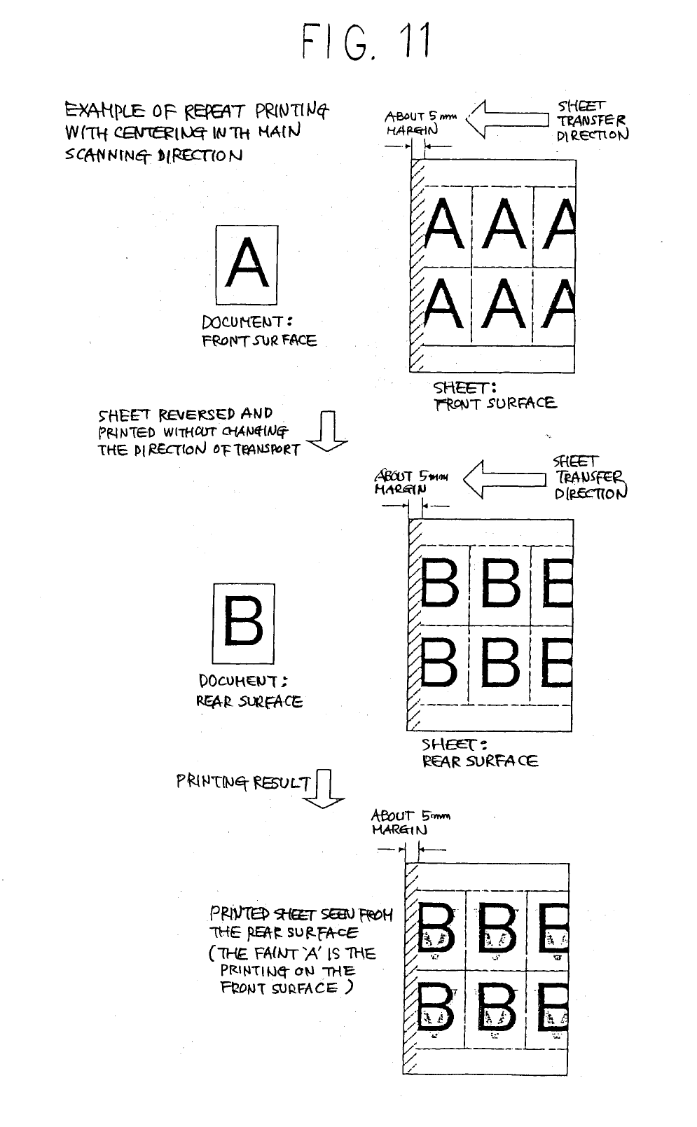

FIG. 10 shows an example in which plate making is carried out when the document 60 image is arranged by being rotated through 180 degrees as described above (in this case the arrangement uses the sheet trailing edge as standard), and repeat printing is carried out on the print sheet P. The print image corresponding to the document image formed on the sheet is arranged by being rotated through 180 degrees, based on the image size input by the image size input means and the detection results of the sheet size detection means. Images are printed using the sheet trailing edge as standard, so defective images as a result of the leading edge margin are reduced, and the number of normally printed images can be increased.

### EXAMPLE 2

In Example 1 above, defective images as a result of the leading edge margin are reduced, and the number of normally printed images can be increased. However, images can be clipped at the top or bottom of the sheet (the end portions in the main scanning direction). Therefore in the present example a function of carrying out an image centering process is provided. In other words, the control means 98 includes the function of carrying out an image centering process. The control means 98 calculates the number of images that can be repeated from the length of the repeat document in the main scanning direction and the length of the print sheet in the main scanning direction. Then a centering process is carried out in the main scanning direction for that number of repeat processed images (more specifically, a centering process is carried out in the main scanning direction using the total length of the repeated images and the length of the print sheet in the main scanning direction). In this way, it is possible to arrange the print images after the repeat process in the center of the sheet in the main scanning direction.

More specifically, in the printer 1 in the present example, if the prepress start key is pressed with the repeat printing function and the centering in the main scanning direction function set, the prepress operation starts. Then the control means 98 calculates the number of images that can be repeated from the length in the main scanning direction of the repeat document and the length in the main scanning direction of the print sheet. This number of images are formed after being centered, and the plate making process is carried out. Then the plate supply and plate setting processes are carried out. Then the various printing conditions are set, the printing start key 82 is pressed, and the repeat printing operation is carried out.

Here, FIG. 11 shows an example of double-sided repeat printing on a print sheet, using the printer explained in Example 2, with the repeat printing function and the centering in the main scanning direction function set. It is possible to arrange the print images after the repeat process in the center of the sheet in the main scanning direction, for both front and rear surfaces. In this way, centering using the trailing edge of the sheet as the standard position is possible. Also, if the same operation is carried out on the rear surface when printing double-sided, the image positions on the front and rear surfaces can be made to coincide on the sheet.

### EXAMPLE 3

In Example 2 described above, an example was given in which double-sided repeat printing was carried out, with the repeat printing function and the centering in the main scanning direction function set. However, by simply centering only, the problem of clipping the images at the leading edge of the sheet is not solved. Also, in the configuration in which images are arranged by being rotated through 180 degrees as explained in Example 1, the number of images that are defective due to the margin on the leading edge is reduced, and the number of normally printed images can be increased. However, clipping of images can occur at the top or bottom of the sheet (the end portions in the main scanning direction). Therefore the present example is provided with a function to carry out image centering and a function to rotate images through 180 degrees and arrange the images. In other words, the control means 98 is provided with the function to carry out image centering and the function to rotate images through 180 degrees and arrange the images. The control means 98 calculates the number of images that can be repeated from the length in the main scanning direction of the repeat document and the length in the main scanning direction of the print sheet. The centering process in the main scanning direction is carried out on the repeated images for this number of images. (More specifically, the centering process in the main scanning direction is carried out for the total length of the repeated images and the length in the main scanning direction of the print sheet.) In addition, the images that have been centered are arranged by being rotated through 180 degrees. In this way, it is possible to arrange the print images that have been repeated in the center of the sheet in the main scanning direction, and make the center of the trailing edge of the sheet the standard position. Furthermore, by rotating through 180 degrees and arranging the images after carrying out the centering process, the images are printed with the trailing edge of the sheet as the standard. Therefore the number of repeat images that are defective due to the leading edge margin is reduced, and the number of normally printed repeat images is increased. In addition, when double-sided printing, by carrying out the same operation on the front and rear surfaces and carrying out printing, it is possible to make the image positions on front and rear coincide when opening vertically.

More specifically, in the printer 1 in the present example, when the prepress start key is pressed with the repeat function, the centering in the main scanning direction function, and the 180 degrees rotation function being set, and the prepress operation starts, the control means 98 calculates the number of images that can be repeat printed in the main scanning direction, from the length in the main scanning direction of the repeat document and the length in the main scanning direction of the print sheet, forms the images after the repeat process and the centering process in accordance with the number of images thus calculated, and further arranges the plate images in the state where the plate images are rotated through 180 degrees, and caries out the plate making. Then, the plate supply and plate setting operations are carried out, and the various print conditions are set. Then the printing start key 82 is pressed, and the repeat printing operation is carried out.

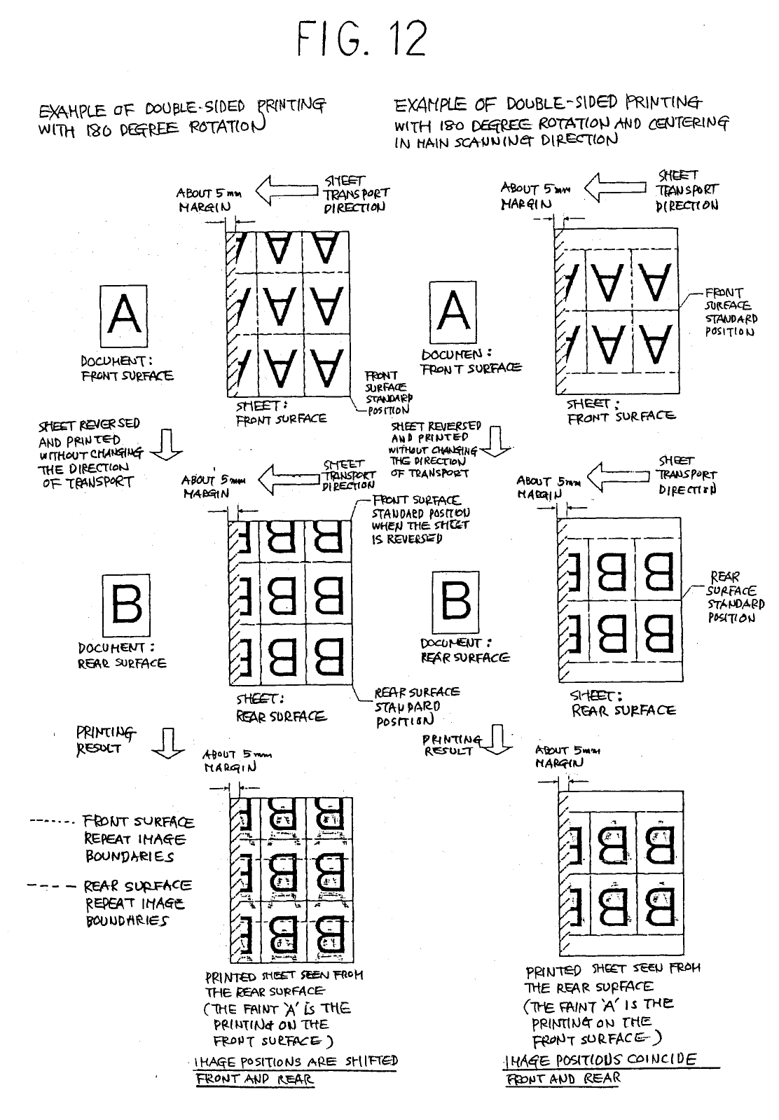

Here, FIG. 12 shows a comparison example, in which the printer explained in example 2 is used to carry out repeat printing on both sides of the print sheet. The comparison examples are the case where the repeat printing function and the 180 degrees rotation function are set and double-sided repeat printing is carried out onto sheets, and the case where the repeat printing function, the 180 degrees rotation function, and the centering in the main scanning direction function are set and double-sided repeat printing is carried out onto sheets. As shown in FIG. 12, in double-sided printing with 180 degree rotation only, the image positions front and rear are shifted in the vertical direction (the main scanning direction). However, in double-sided printing with 180 degree rotation and centering in the main scanning direction, the image positions coincide front and rear.

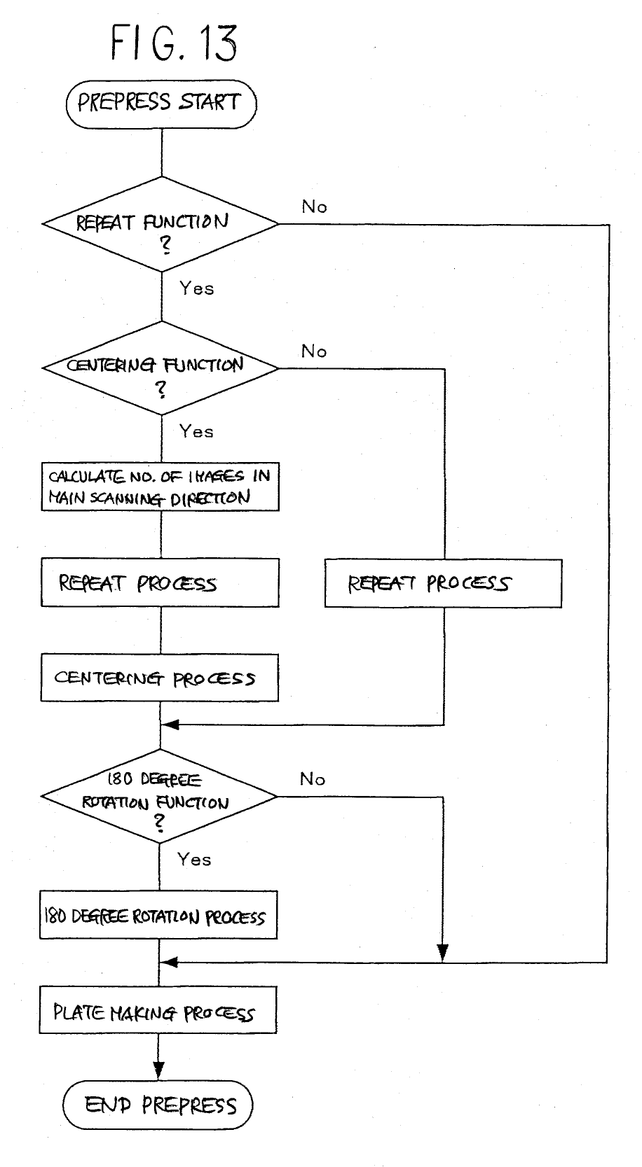

FIG. 13 is a flowchart showing the control operation of the prepress process, corresponding to the examples 1 through 3 described above. If the repeat process only is set and the prepress process is carried out, the printed image is as shown in FIG. 9. If the repeat function and the 180 degree rotation function are set as in example 1, and the prepress process carried out, the printed image is as shown in FIG. 10. If the repeat function and the centering function are set as in example 2, and the prepress process carried out, the printed image when carrying out double-sided printing is as shown in FIG. 11. If the repeat function and the 180 degree rotation function are set, and the prepress process carried out, the printed image when carrying out double-sided printing is as shown in the left side of FIG. 12. If the repeat function, the 180 degree rotation function, and the centering function are set, and the prepress process carried out as in example 3, the printed image when carrying out double-sided printing is as shown in the right side of FIG. 12.

From the above it can be seen that for single-sided repeat printing only, the setting in example 1 is good. However, for double-sided repeat printing, the setting of example 3, which combines the functions of example 1 and example 2, is good. In this way, the number of images that are defective due to the margin on the leading edge is reduced, and the number of normally printed images can be increased. In addition, when the same operation is carried out on the rear surface when carrying out double-sided printing, it is possible to make the image positions coincide on the front and rear with vertical opening.

### EXAMPLE 4

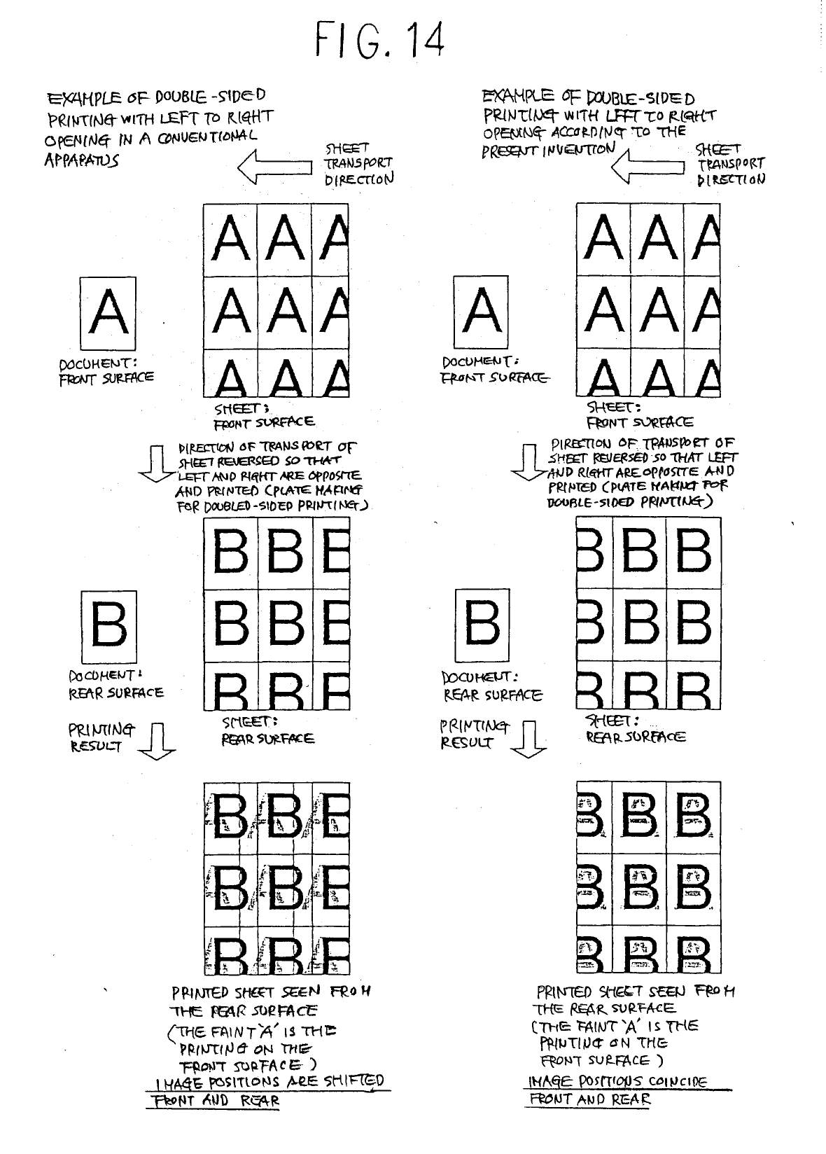

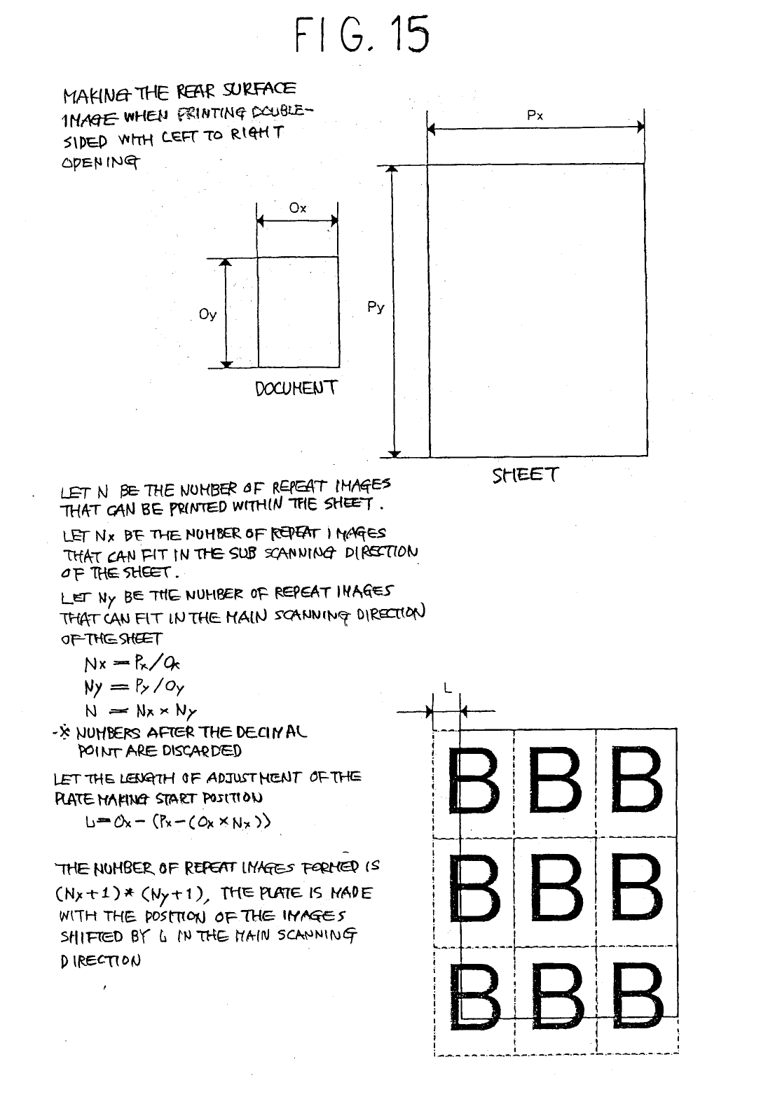

When carrying out double-sided repeat printing with the printer explained in the second embodiment, after the front surface has been printed the sheet is reversed, and the direction of transport is reversed left to right. Therefore, as shown in the left hand side of FIG. 14, the printed state of both the front and rear surfaces are in the same state. Therefore the image positions on front and rear are shifted in the horizontal direction when opening left to right.

Therefore, in the present example, when making the plate for the rear surface when double-sided printing, the length that the image protruded from the trailing edge of the front surface is calculated. Then the start position on the rear surface plate is shifted by this length in the sub scanning direction, and the image is output. In this way, as shown in the right hand side of FIG. 14, the image position on the front and rear of the sheet can be made to coincide when opening left to right.

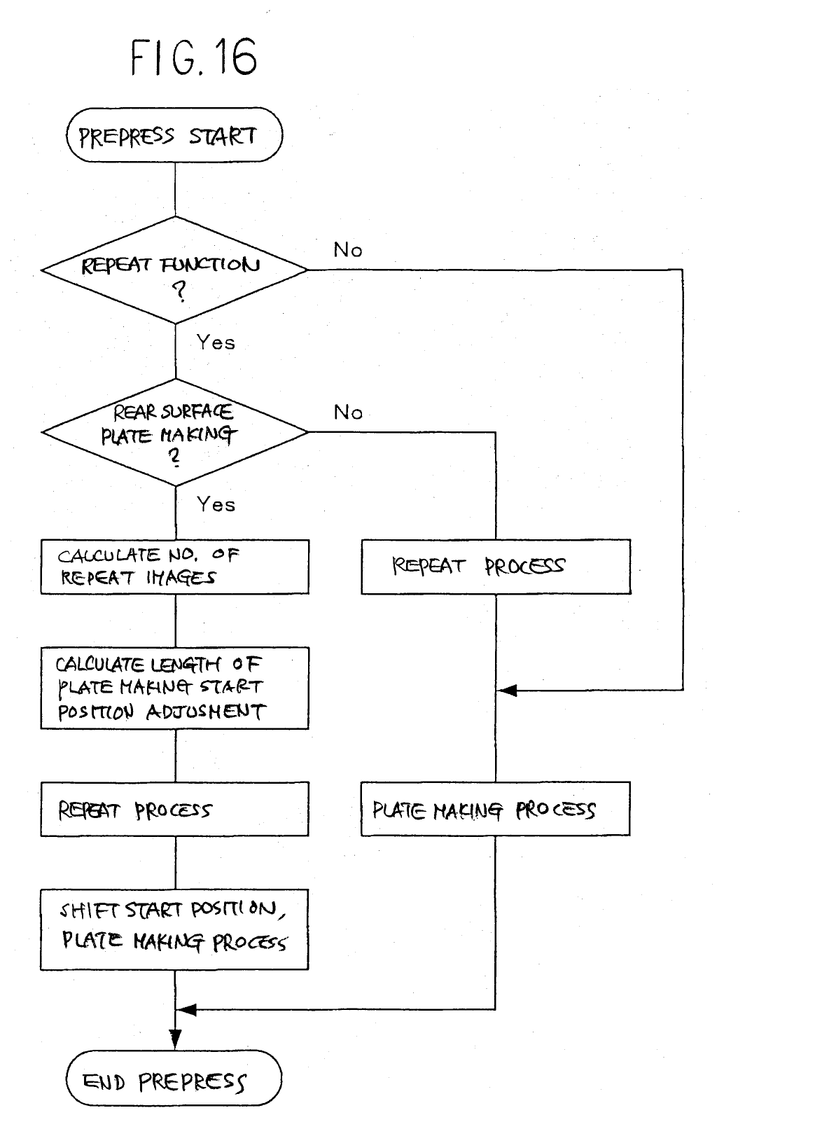

Here, FIG. 15 shows an example of making the reverse surface image when printing double-sided with left to right opening. FIG. 16 is a flowchart showing the control operation of the plate making process when making the rear surface plate.

In the present example, when making the rear surface plate for double-sided printing, the control means 98 calculates the length L of image protruding from the trailing edge when making the front surface plate, shifts the rear surface plate making start position by the length L in the sub scanning direction (direction of transport of the sheet), and carries out plate making for the rear surface image.

More specifically, assume the length in the sub scanning direction of the document is Ox, the length in the main scanning direction of the document is Oy, the length in the sub scanning direction of the print sheet is Px, the length in the main scanning direction of the print sheet is Py, the number of repeat images that can be printed within a print sheet is N, the number of repeat images that can fit onto the print sheet in the sub scanning direction is Nx, and the number of repeat images that can fit onto the print sheet in the main scanning direction is Ny. Then

Nx=Px/Ox

Ny=Py/Oy

N=Nx×Ny

(numbers to the right of the decimal point are discarded)

Then the adjustment length L of the plate making start position is,

L=Ox−(Px−(Ox×Nx))

Also, (Nx+1)×(Ny+1) repeat images are created, and the rear surface plate making start position is shifted by L in the sub scanning direction, and plate making the rear surface image is carried out.

In this way, when carrying out double-sided printing with left to right opening, the image length L that protrudes from the trailing edge when the front surface plate is made is calculated. Then the rear surface plate making start position is shifted in the sub scanning direction by this amount L, and the image is output. Therefore the image position on the front and rear of the sheet can be made to coincide when printing double-sided with left to right opening.

### EXAMPLE 5

In the configuration in example 4 described above, the image position on the front and rear of the sheet can be made to coincide when printing double-sided with left to right opening. However, images that are unusable because of image clipping at the leading edge of the sheet can occur.

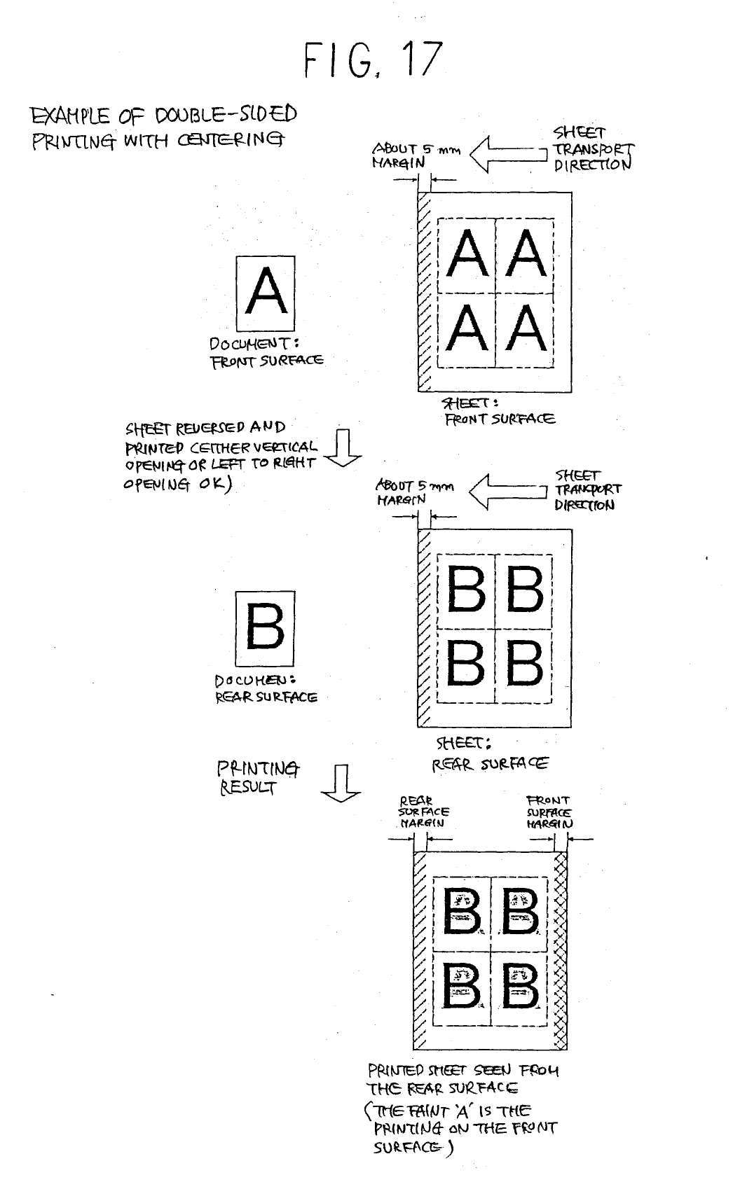

Therefore in the present example when printing double-sided with left to right opening, the number of images that can be repeated within the print sheet is calculated from the length in the main scanning direction of the repeat document, the length in the main scanning direction of the print sheet, the length in the sub scanning direction of the repeat document, and the length in the sub scanning direction of the print sheet. Then a centering process is carried out on that number of images that have been repeat processed. In this way, as shown in FIG. 17, the image positions can be made to coincide front and rear when printing double-sided and opening left to right, and at the same time the number of images that are unusable as a result of image clipping at the leading edge of the sheet can be reduced.

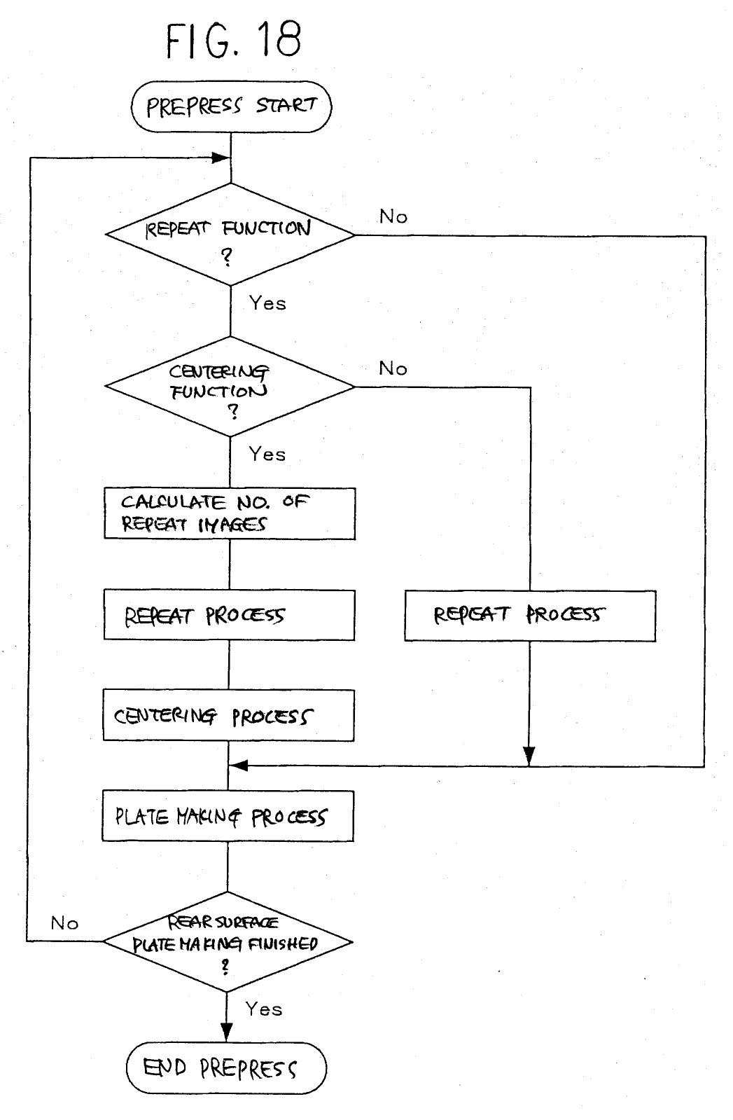

Here, FIG. 18 is a flowchart that shows the control operation of the plate making process when making the rear surface plate.

In the present example, when the prepress operation starts with the repeat function and the centering function set, the control means 98 calculates the number of images that can be repeated within the print sheet from the length in the main scanning direction of the repeat document, the length in the main scanning direction of the print sheet, the length in the sub scanning direction of the repeat document, and the length in the sub scanning direction of the print sheet. A centering process is carried out on the images that have been repeated this number of times. Then the centered plate images are formed and plate making is carried out. FIG. 18 shows the control operation of the plate making process when making the rear surface plate, but the operation for the front surface is the same.

With the printer shown in FIG. 4, by carrying out the plate making process as described above, and carrying out double-sided printing as stated previously, the printing result shown in FIG. 17 is obtained. It is possible to make the image positions on front and rear coincide when opening left to right, and reduce the number of images that are unusable due to image clipping on the leading edge of the sheet. Also, in this system, a centering process is carried out with respect to the top and bottom of the sheet, so it is also possible to make the image positions coincide front and rear with vertical opening.

As stated above, according to the present invention the following effects can be obtained.

(1) The printer according to the first means includes image size input means for inputting the lengths of the document image in the main scanning direction and the sub scanning direction, and sheet size detection means that detects the sheet size. When using the image division printing function, the print images corresponding to the document images formed on the sheet are arranged by being rotated through 180 degrees on the sheet, based on the image size input by the image size input means and the detection results of the sheet size detection means. In this way images are printed using the trailing edge of the sheet as standard, so clipping of some of the images due to the margin at the leading edge is reduced, and the number of normally printed images can be increased.

(2) The printer according to the second and third means includes image size input means for inputting the lengths of the document image in the main scanning direction and the sub scanning direction, and sheet size detection means that detects the sheet size. When using the image division printing function, print images corresponding to the document images formed on the sheet are arranged by carrying out either one or both of a rotation through 180 degrees process or a centering process, based on the image size input by the image size input means and the detection results of the sheet size detection means. In this way, when carrying out single-sided printing, images are printed using the trailing edge of the sheet as standard, the same as the first means. Therefore clipping of some of the images due to the margin at the leading edge is reduced, and the number of normally printed images can be increased. Also, when carrying out double-sided printing, the image positions can be made to coincide in the front and rear of the sheet.

(3) The printer according to the fourth means includes a function of carrying out repeat processing for forming a plurality of the same document image, as an image division printing function. The number of images that can be repeated is calculated from the length in the main scanning direction of the repeat document and the length in the main scanning direction of the print sheet. A centering process in the main scanning direction is carried out on the images that have been repeated by this number. More specifically, a centering process is carried out in the main scanning direction using the total length of the repeated images and the length in the main scanning direction of the print sheet. In this way, the print images after repeat processing can be arranged in the center in the main scanning direction of the sheet. In this way, the center of the trailing edge of the sheet can be made the standard position, and if a similar operation is carried out rear surface of the sheet when carrying out double-sided printing, the image positions on the front and rear of the sheet can be made to coincide when opening left to right.

(4) In the printer according to the fifth means, the number of images that can be repeated is calculated from the length in the main scanning direction of the repeat document and the length in the main scanning direction of the print sheet. A centering process in the main scanning direction is carried out on the images that have been repeated by this number. More specifically, a centering process is carried out in the main scanning direction using the total length of the repeated images and the length in the main scanning direction of the print sheet. In this way, the print images after repeat processing can be arranged in the center in the main scanning direction of the sheet. In this way, the center of the trailing edge of the sheet can be made the standard position. Furthermore, by rotating through 180 degrees and arranging the images on which the centering process has been carried out, the number of images that are clipped due to the leading edge margin is reduced, and it is possible to increase the number of normally printed repeat images. In addition, if the same operation is carried out on the rear surface of the sheet when printing double-sided, it is possible to make the position of the images coincide on the front and rear of the sheet with left to right opening.

(5) In the printer according to the sixth means, when making the rear surface plate for double-sided printing, the length of image protruding from the trailing edge when making the front surface plate is calculated, the rear surface plate making start position is shifted in the sub scanning direction by this length, and the image is output. In this way, the image position on the front and rear of the sheet can be made to coincide for left to right opening.

(6) In the printer according to the seventh means, the number of images that can be repeated within the print sheet is calculated from the length in the main scanning direction of the repeat document, the length in the main scanning direction of the print sheet, the length in the sub scanning direction of the repeat document, and the length in the sub scanning direction of the print sheet. By carrying out a centering process on the images that have been repeated by that number, it is possible to make the front and rear image positions coincide when carrying out double-sided printing with left to right opening. In addition it is possible to reduce the number of images that are unusable due to image clipping at the leading edge of the sheet.

Various modifications will become possible for those skilled in the art after receiving the teachings of the present disclosure without departing from the scope thereof.

What is claimed is:

1. A printer having an image division printing function of forming a plurality of print images on a single sheet, comprising:
an image reading unit that reads document images;
a plate making unit that makes master plates;
a printing unit having a cylinder around which a master made in the plate making unit is wound, and a pressure member that presses sheets against the cylinder;
a sheet supply unit that supplies sheets to the printing unit;
image size input means for inputting the length of the document image in a main scanning direction and a sub scanning direction; and
sheet size detection means for detecting the size of the sheets,
wherein when using the image division printing function, print images corresponding to the document images formed on the sheet are arranged by being rotated through 180 degrees, based on the image size input by the image size input means and the detection results of the sheet size detection means.

2. The printer as claimed in claim 1, wherein the printer has a function of carrying out a repeat process in which a plurality of the same document image is formed as the image division printing function, the number of images that can be repeated is calculated from the length in the main scanning direction of the document on which the repeat process is carried out (hereafter referred to as a repeat document) and the length in the main scanning direction of the print sheet, and a centering process is carried out in the main scanning direction on the images on which the repeat process has been carried out in accordance with the calculated number.

3. The printer as claimed in claim 2, wherein the number of images that can be repeated is calculated from the length in the main scanning direction of the repeat document and the length in the main scanning direction of the print sheet, and the images on which the repeat process in accordance with the calculated number and the centering process in the main scanning direction have been carried out are arranged by being rotated through 180 degrees.

4. The printer as claimed in claim 2, wherein the number of images that can be repeated within the sheet is calculated from the length in the main scanning direction of the repeat document, the length in the main scanning direction of the print sheet, the length in the sub scanning direction of the repeat document, and the length in the sub scanning direction of the print sheet, and a centering process is carried out on the images on which the repeat process has been carried out in accordance with the calculated number.

5. A printer having an image division printing of forming a plurality of print images on a single sheet, and a double-sided printing function of printing both sides of the sheet, comprising:
a printing unit having a cylinder around the outer peripheral surface of which a divided plate master having a first plate image and a second plate image aligned in a length direction is wound, and a pressure member that can freely contact with and separate from the cylinder;
a sheet supply unit that supplies sheets to the printing unit;
a sheet discharge unit that discharges sheets that have been printed in the printing unit outside the printer;
an auxiliary tray that temporarily stores sheets for which a print image has been formed on the front surface thereof in the printing unit;
sheet re-supply means for re-supplying to the printing unit the sheets that have been printed on the front surface thereof and that are stored in the auxiliary tray;
a switching member that guides sheets that have passed the printing unit to either the auxiliary tray or the sheet discharge unit;
image size input means for inputting the length of a document image in a main scanning direction and a sub scanning direction; and
sheet size detection means for detecting the size of the sheets,
wherein when using the image division printing function, print images corresponding to the document images formed on the sheet are arranged by carrying out either one or both of a rotation through 180 degrees process and a centering process, based on the image size input by the image size input means and the detection results of the sheet size detection means.

6. The printer as claimed in claim 5, wherein when carrying out double-sided printing, a first sheet is supplied from the sheet supply unit to the printing unit, either the first plate image or the second plate image is printed on the front surface of the first sheet, the printed first sheet is guided to the auxiliary tray by the switching member, then a second sheet is supplied from the sheet supply unit to the printing unit, one of either the first plate image or the second plate image is printed on the front surface of the second sheet, the first sheet is re-supplied to the printing unit by the sheet re-supply means and the other of either the first plate image or the second plate image is printed on the rear surface of the first sheet, the first sheet is guided to the sheet discharge unit by the switching member, and the second sheet is guided to the auxiliary tray.

7. The printer as claimed in claim 5, wherein the printer has a function of carrying out a repeat process in which a plurality of the same document image is formed as the image division printing function, the number of images that can be repeated is calculated from the length in the main scanning direction of the document on which the repeat process is carried out (hereafter referred to as a repeat document) and the length in the main scanning direction of the print sheet, and a centering process is carried out in the main scanning direction on the images on which the repeat process has been carried out in accordance with the calculated number.

8. The printer as claimed in claim 7, wherein the number of images that can be repeated is calculated from the length in the main scanning direction of the repeat document and the length in the main scanning direction of the print sheet, and the images on which the repeat process in accordance with the calculated number and the centering process in the main scanning direction have been carried out are arranged by being rotated through 180 degrees.

9. The printer as claimed in claim 7, wherein the number of images that can be repeated within the sheet is calculated from the length in the main scanning direction of the repeat document, the length in the main scanning direction of the print sheet, the length in the sub scanning direction of the repeat document, and the length in the sub scanning direction of the print sheet, and a centering process is carried out on the images on which the repeat process has been carried out in accordance with the calculated number.

10. The printer as claimed in claim 5, wherein when making the plate for the rear surface in a case of carrying out double-sided printing, the length of the image that protrudes from the trailing edge when making the plate for the front surface is calculated, the rear surface plate making start position is shifted in the sub scanning direction by the calculated length, and the image is output.

11. The printer as claimed in claim 10, wherein the number of images that can be repeated within the sheet is calculated from the length in the main scanning direction of the repeat document, the length in the main scanning direction of the print sheet, the length in the sub scanning direction of the repeat document, and the length in the sub scanning direction of the print sheet, and a centering process is carried out on the images on which the repeat process has been carried out in accordance with the calculated number.
